(19) United States
(12) Patent Application Publication
(10) Pub. No.: US 2022/0376453 A1
(43) Pub. Date: Nov. 24, 2022

(54) PLASMA GRATINGS FOR HIGH-INTENSITY LASER PULSE COMPRESSION

(71) Applicant: Lawrence Livermore National Security, LLC, Livermore, CA (US)

(72) Inventors: Matthew Reid Edwards, Livermore, CA (US); Pierre Michel, Oakland, CA (US)

(21) Appl. No.: 17/740,105

(22) Filed: May 9, 2022

Related U.S. Application Data
(60) Provisional application No. 63/186,711, filed on May 10, 2021.

(51) Int. Cl. H01S 3/00; H01S 3/08; H01S 3/23

(52) U.S. Cl. CPC H01S 3/0057; H01S 3/08009; H01S 3/2308

(57) ABSTRACT

A diffractive optical element, such as a plasma grating, can be made by directing two laser beams so that they overlap in a nonlinear material to form an interference pattern in the nonlinear material. The interference pattern can modify the index of refraction in the nonlinear material to produce the diffractive optical element. A chirped pulse amplification system can stretch, amplify, and then compress a laser pulse, and the plasma grating can be used to compress the laser pulse since the plasma optic can withstand the high light intensity of the compressed pulse.

### CROSS-REFERENCE TO RELATED APPLICATIONS

This application claims the benefit under 35 U.S.C. § 119(e) of U.S. Provisional Patent Application No. 63/186,711, filed May 10, 2021, and titled PLASMA GRATINGS FOR HIGH-INTENSITY LASER PULSE COMPRESSION. The entirety contents of each of the above-identified application(s) are hereby incorporated by reference herein and made part of this specification for all that they disclose.

### FEDERALLY SPONSORED RESEARCH OR DEVELOPMENT

This invention was made with Government support under Contract No. DE-AC52-07NA27344 awarded by the United States Department of Energy. The Government has certain rights in the invention.

### BACKGROUND

### Field of the Disclosure

Some embodiments disclosed herein relate to diffractive optical elements formed in a nonlinear medium, such as plasma transmission gratings, and to compression of laser pulses.

### Description of the Related Art

Although various laser pulse compressors exist, there remains a need for improved high power laser pulse compressors.

### SUMMARY

Certain example embodiments are summarized below for illustrative purposes. The embodiments are not limited to the specific implementations recited herein. Embodiments may include several novel features, no single one of which is solely responsible for its desirable attributes or which is essential to the embodiments.

Some embodiments disclosed herein can relate to a laser pulse compressor, which can include a medium, or a supply configured to provide a medium, or a support configured to hold a medium. The compressor can include at least one laser configured to provide first and second laser beams that are disposed with respect to each other and with respect to the medium so that the first and second laser beams interfere and form an interference pattern on the medium to produce a diffraction grating. The compressor can include one or more optical elements configured to receive a third laser beam that comprises a laser pulse having a first pulse width and including light of different wavelengths, to direct the different wavelengths of light along different paths with different distances, and to direct the different wavelengths of light to the diffraction grating formed in the medium. The diffraction grating formed in the medium can be configured to diffract the light of different wavelengths to produce an output laser pulse having a second pulse width that is shorter the first pulse width. In some embodiments, the compressor can include a first dispersive optical element configured to disperse a third laser beam that comprising a laser pulse having a first pulse width and including multiple wavelengths so that light of different wavelengths of the third laser beam propagate away from the first dispersive optical element at different angles. The diffraction grating can be configured to receive the light of different wavelengths from different incoming angles and to diffract the light so that the light of different wavelengths propagates away from the diffraction grating at substantially the same angle to produce an output laser pulse having a second pulse width that is shorter the first pulse width. The laser pulse compressor can be used in a chirped pulse amplification system, which can include a chromatic stretcher configured to chromatically stretch a laser pulse, an amplifier to amplify the laser pulse, and the laser pulse compressor configured to chromatically compress the laser pulse.

Some embodiments disclosed herein can relate to a system that includes a medium, or a supply configured to provide a medium, or a support configured to hold a medium. The system can have at least one laser configured to provide first and second laser beams that are disposed with respect to each other and with respect to the medium so that the first and second laser beams interfere and form an interference pattern on the medium to produce a diffraction grating, which can be a transmission grating. The system can have one or more optical elements configured to direct different wavelengths of light to converge at the diffraction grating at different angles. The diffraction grating can be configured to diffract the light to reduce the difference in angles between the different wavelengths of light. In some embodiments, the diffraction grating can be configured to output the light of different wavelengths at substantially the same angle. The diffraction grating can be used for laser pulse compression. The diffraction grating can be used for chirped pulse amplification.

Some embodiments disclosed herein can relate to a method of compressing a laser pulse. The method can include directing first and second pump laser beams to a medium. The first and second pump laser beams can at least partially intersect at the medium so that the first and second pump laser beams interfere to form an interference pattern at the medium to produce a diffraction grating. The method can include receiving a laser pulse having a first pulse width and a wavelength distribution of light of different wavelengths across the laser pulse. The method can include directing the light of different wavelengths to the diffraction grating along different paths having different distances. The method can include diffracting the light of different wavelengths using the diffraction grating produced at the medium to produce an output laser pulse having a second pulse width that is shorter than the first pulse width. The method can include directing a laser pulse to a first dispersive optical element. The laser pulse can have a first pulse width and a wavelength distribution of light of different wavelengths across the laser pulse. The method can include dispersing the laser pulse using the first dispersive optical element so that the light of different wavelengths propagates away from the first dispersive optical element at different angles, and directing the light of different wavelengths along different paths having different distances so that the light of different wavelengths converges at the diffraction grating produced at the medium. The method can include diffracting the light of different wavelengths using the diffraction grating produced at the medium to reduce the convergence of the light of different wavelengths (e.g., in some embodiments so that the light of different wavelengths propagates away from the diffraction grating at substantially the same angle) to produce an output laser pulse having a second pulse width that is shorter than the first pulse width.

Some embodiments disclosed herein can relate to a method that includes directing first and second pump laser beams to a medium. The first and second pump laser beams can at least partially intersect at the medium so that the first and second pump laser beams interfere to form an interference pattern at the medium to produce a diffraction grating. The method can include directing light of different wavelengths to the diffraction grating at different incoming angles so that the diffraction grating diffracts the light to reduce the difference in angles between the different wavelengths of light. The method can include directing light of different wavelengths to the diffraction grating at different incoming angles so that the diffraction grating diffracts the light so that the light of different wavelengths propagates away from the diffraction grating at substantially the same outgoing angle.

Some embodiments disclosed herein can relate to a laser pulse compressor, which can include a plasma grating. The laser pulse compressor can include one or more optical elements configured to direct different wavelengths of light of a laser pulse along different path lengths and to direct the different wavelengths of light to the plasma grating. The plasma grating can be a transmission grating. Some embodiments disclosed herein relate to a chirped laser pulse amplification system that can use the plasma grating, for example as a final grating that outputs an amplified laser pulse.

Some embodiments disclosed herein can relate to a chirped laser pulse amplification system. The system can include a laser pulse stretcher configured to increase a pulse width of a laser pulse to provide a stretched laser pulse. The system can include an amplifier configured to amplify the stretched laser pulse to provide an amplified stretched laser pulse. The system can include a laser pulse compressor configured to decrease a pulse width of the amplified stretched laser pulse to provide an output laser pulse, which can be an amplified laser pulse and/or a compressed laser pulse. The laser pulse compressor can include a plasma grating.

Some embodiments disclosed herein can relate to a chirped laser pulse amplification system. The system can include a laser pulse stretcher configured to increase a pulse width of a laser pulse to provide a stretched laser pulse. The system can have an amplifier configured to amplify the stretched laser pulse to provide an amplified stretched laser pulse. The system can have a laser pulse compressor that includes a plasma grating and is configured to compress the amplified stretched laser pulse to provide a compressed laser pulse. In some embodiments, the system can have a first laser pulse compressor configured to perform a first compression on the amplified stretched laser pulse to provide a partially compressed laser pulse, and a second laser pulse compressor configured to perform a second compression on the partially compressed laser pulse to provide a compressed laser pulse, and the second laser pulse compressor can include a plasma grating.

### BRIEF DESCRIPTION OF THE DRAWINGS

Certain embodiments will be discussed in detail with reference to the following figures, wherein like reference numerals refer to similar features throughout. These figures are provided for illustrative purposes and the embodiments are not limited to the specific implementations illustrated in the figures.

FIG. 1 shows an example embodiment for a system for making an optical element.

FIG. 2 shows another example embodiment for a system for making an optical element.

FIG. 3 shows another example embodiment for a system for making an optical element.

FIG. 4 shows another example embodiment for a system for making an optical element.

FIG. 5 shows an example embodiment of first and second pump beams being directed to a medium to produce a grating.

FIG. 6 shows an example embodiment of a grating.

FIG. 7 shows an example embodiment of a chirped laser pulse amplification system employing a grating such as shown in FIG. 6.

FIG. 8 is a graph showing an example design space for pulse compressors.

FIG. 9 shows an example embodiment of a beam diffracted by a grating in a medium.

FIG. 10 is a graph showing how changing the wavelength of incident light can affect the diffraction angle and efficiency.

FIG. 11 is a graph showing pulses before and after operation of a pulse compressor with a plasma grating.

FIG. 12 shows a pulse diffracted by a plasma grating.

FIG. 13 shows a compressed laser pulse.

FIG. 14 is a graph showing efficiency as the pulse intensity increases.

### DETAILED DESCRIPTION OF CERTAIN EMBODIMENTS

The various features and advantages of the systems, devices, and methods of the technology described herein will become more fully apparent from the following description of the examples illustrated in the figures. These examples are intended to illustrate the principles of this disclosure, and this disclosure should not be limited to merely the illustrated examples. The features of the illustrated examples can be modified, combined, removed, and/or substituted as will be apparent to those of ordinary skill in the art upon consideration of the principles disclosed herein.

Diffraction gratings and other optical elements (e.g., diffractive and/or dispersive optical elements) can be made from glass, polymers, films, or other materials that can be damaged by high intensity light, such as from high power lasers (e.g., high power laser pulses). In some instances, the power of a laser pulse can be spread over a larger spatial area or over a larger pulse width or duration to avoid or reduce damage from high intensity light. However, the large pulse widths and/or large size of the optical elements can be incompatible with some systems, and the large optical elements can be prohibitively expensive, especially for very high power applications. In some configurations, a system for producing a laser pulse with high intensity and/or a short pulse width (e.g., an ultrashort laser pulse) can expose a diffractive optical element used to compress the pulse to the full intensity of the output laser pulse. Thus, the peak power of the laser can be limited by the damage threshold of the diffractive optical element.

For example, in a chirped pulse amplification system, a laser pulse can be chromatically stretched, then amplified, and then compressed to provide a laser pulse with high peak power. In the chirped pulse amplification system, a diffraction grating, or other diffractive or dispersive optical element, can be exposed to substantially the full peak power of the compressed laser pulse when compressing the pulse. Thus, the peak power of the laser (e.g., for femtosecond lasers) can be limited by the damage threshold of the final grating, which can impose a bottleneck in reaching higher powers.

Some embodiments disclosed herein can create an optical element (e.g., a diffraction grating) from plasma, which can be less susceptible to damage from high intensity light as compared to solid-state optical materials. In various implementations, for example, two pump laser beams can be directed so that they intersect or overlap in a medium (e.g., a nonlinear medium). This nonlinear medium may have an index of refraction that varies with the intensity of light incident thereon, for example, when such intensities are sufficiently high. The nonlinear medium may comprise, for example, gas that may in some cases be ionized. Accordingly, in various implementations, the pump beams may be directed into gas, or a gas stream, or a gas jet. The term gas jet can refer to the gas itself, which can be a stream of gas, which can be emitted from a nozzle or other device. The two pump laser beams can optically interfere with each other, and can produce an interference pattern in the nonlinear medium such as in the gas. The interference pattern can alter an optical characteristic of medium, such as the index of refraction, which can produce a diffraction grating that corresponds to the interference pattern (e.g., in shape, size, grating spacing, etc.)

Without subscribing to any particular scientific theory, in some cases, for example, the interference pattern can produce spatially variant ionization (SVI) in the medium (e.g., gas), with areas of constructive interference having more plasma (e.g., less neutral gas) and with areas of destructive interference having less plasma (e.g., more neutral gas). The ionized gas of the plasma can have a lower index of refraction than the non-ionized gas (e.g., neutral gas), so that the interference pattern can produce variability in the index of refraction in the medium. Spatially controlled ionization can be used, where the highest-intensity regions of the interference pattern are above the ionization threshold of the medium while lower-intensity regions of the interference pattern are below the ionization threshold, thereby producing an alternating pattern of plasma and neutral gas. In some cases, the interference pattern can produce ponderomotively-forced plasma density fluctuations that create variations in the index of refraction in the nonlinear medium. For example, ions, as charged particles, can move based on the gradient in electric field created by the higher and lower intensity light in the interference pattern. In some embodiments, the medium can have plasma at both the constructive and destructive interference portions of the interference pattern and ponderomotive ion forcing can produce different densities of plasma, and therefore different indices of refraction, at the constructive and destructive interference portions. Some embodiments can use ponderomotive electron forcing, where electrons (e.g., plasma electrons) are ponderomotively driven by the interference pattern but the timing is too short for significant ion motion, to produce different indices of refraction at the high and low intensity regions of the interference pattern. Some embodiments disclosed herein can make or use a plasma grating, such as a plasma volume transmission grating. In some embodiments, the density of the non-plasma medium (e.g., non-ionized gas) can be modulated by the interference pattern, which can correspondingly modulate the indices of refraction, to produce a non-ionized optical element (e.g., diffraction grating). Any suitable mechanisms for producing interference pattern variations in the index of refraction within the nonlinear medium are possible, as well as suitable combinations thereof.

Any suitable medium can be used in which the index of refraction can vary depending on the intensity of light, so that the interference pattern between the two pump beams can modify the index of refraction across the medium. However, as discussed herein, a nonlinear medium comprising a plasma may have the advantage of providing a higher damage threshold than other mediums. Having the ability to withstand high light intensity can thus make such plasma based optical elements, e.g., plasma gratings, useful for high power lasers and laser systems. For example, the plasma grating can be used in a laser pulse compressor or a chirped laser pulse amplification system to output high peak power laser pulses that could damage or destroy conventional solid-state optics.

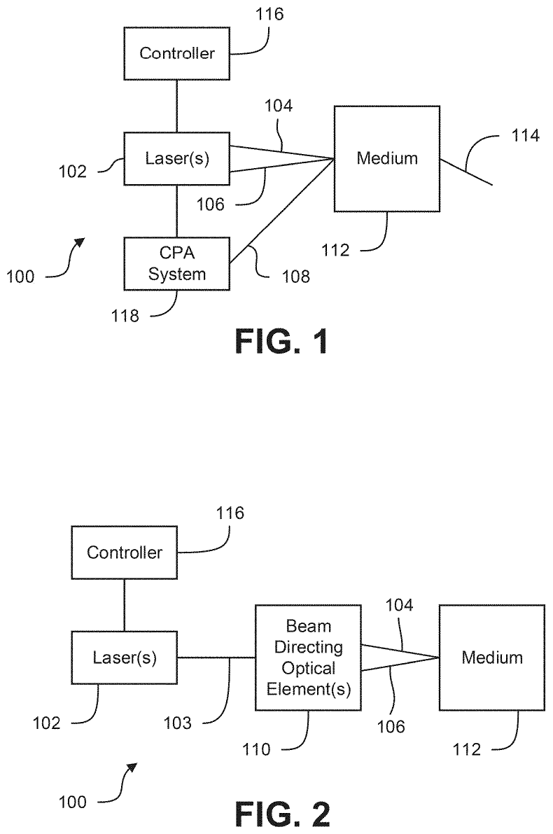

FIG. 1 shows an example embodiment of a system 100 for producing an optical element, such as a diffraction grating (e.g., such as a plasma volume transmission grating). The system 100 can include one or more lasers 102 configured to produce a first pump laser beam 104 and a second pump laser beam 106. The pump laser beams 104 and 106 can be directed to a medium 112, which can be a nonlinear medium. The medium 112 can be a gas, a plasma, a liquid, a solid, or any other suitable material that at can produce a change in the index of refraction that depends on the intensity of light. The first pump laser beam 104 and the second pump laser beam 106 can be directed so that they intersect or overlap each other in the nonlinear medium 112, which can produce an interference pattern in the medium 112. The interference pattern can produce a variable index of refraction in the medium 112, such as by producing a variable distribution of plasma, or any other suitable mode of operation, such as those described herein. A probe laser beam 108 can be directed to the medium 112 with the varying index of refraction to modify (e.g., to diffract or redirect or induce dispersion or any combination thereof) the probe laser beam 108. The system 100 can produce a modified (e.g., diffracted or redirected or dispersed) probe laser beam 114 that can exit the medium 112. In some implementations, a chirped pulse amplification (CPA) system 118 can provide the probe beam 108 to the medium 112, and the grating formed in the medium can be used as the final grating of the CPA system 118, as discussed herein.

In some embodiments, the one or more lasers 102 can be configured to produce laser pulses for the first pump laser beam 104, the second pump laser beam 106, and/or the probe beam 108. The one or more lasers 102 can include one or more femtosecond lasers or one or more picosecond lasers, although any suitable laser(s) can be used. The plasma lens can be produced using femtosecond laser pulses, although picosecond laser pulses could be used, or laser pulses of any suitable duration. Although the variable index of refraction in the medium 112 (e.g., produced by the variable distribution of plasma) can be transient, it can persist long enough to produce an optical element that can operate on the probe laser beam 108 or other light (e.g., such as to diffract and/or introduce disperion in the light). For example, a probe beam 108 can propagate through a transient optical element formed in the medium 112 so that the light of the probe laser beam 108 is modified (e.g., diffracted, dispersed, and/or redirected), as discussed herein. In some embodiments continuous wave laser beams can be used for the pump laser beams 104 and 106.

In some designs, the system can include a controller 116, which can be configured to control the one or more lasers 102, so as to produce the laser pulses for the pump beams 104, 106 and/or the probe beam 108 at the suitable times so that the pump beams 104, 106 are present in the medium 112 at the same time, and/or so that the probe beam 108 is directed through the medium 112 while the optical element (e.g., plasma grating) is present. In some implementations, the controller 116 can include a processor, which can be configured to execute instructions, which can be stored in memory, to implement features disclosed herein, although any suitable configuration for the controller 116 can be used.

With reference to FIG. 2, in some embodiments the system 100 can include one or more optical elements 110, which can be configured to direct the laser beams 104 and 106 to the medium 112. In some embodiments, one laser can be used to produce both the first pump laser beam 104 and the second pump laser beam 106, which can facilitate the delivery of both pump laser beams 104, 106 to the medium 112 at the same time, especially for short duration laser pulses. A laser beam (e.g., comprising laser pulse(s)) can be split (e.g., using a beam splitter) to produce the two pump laser beams 104, 106. Once split, the two pump laser beams 104, 106 can follow different paths with different optical element(s), which can redirect (e.g., reflect) one or both of the two pump laser beams 104, 106 so that they cross, intersect, and/or overlap at the medium 112 and optically interfere. The one or more optical elements 110 for directing the laser beams 104, 106 can include one or more mirrors, lenses, beam splitters, etc.

The same laser that makes either or both of the pump laser beams 104, 106 can also produce the probe laser beam 108, in some implementations. For example, the laser can be configured to produce lower intensity pulses for the pump beams 104, 106 and a higher intensity pulse for the probe beam 108. In other embodiments, a first laser can be used to make the pump laser beams 104, 106 and a second laser can be used to produce the probe laser beam 108, or three different lasers can be used to make the beams 104, 106, 108. Also, in some cases first and second lasers can be used to provide the first and second laser beams 104, 106, respectively. The first pump laser beam 104 and the second pump laser 106 can propagate directly from the respective first and second lasers to the medium 112. The beam directing optical elements 110 can be omitted in some cases, such as in FIG. 1.

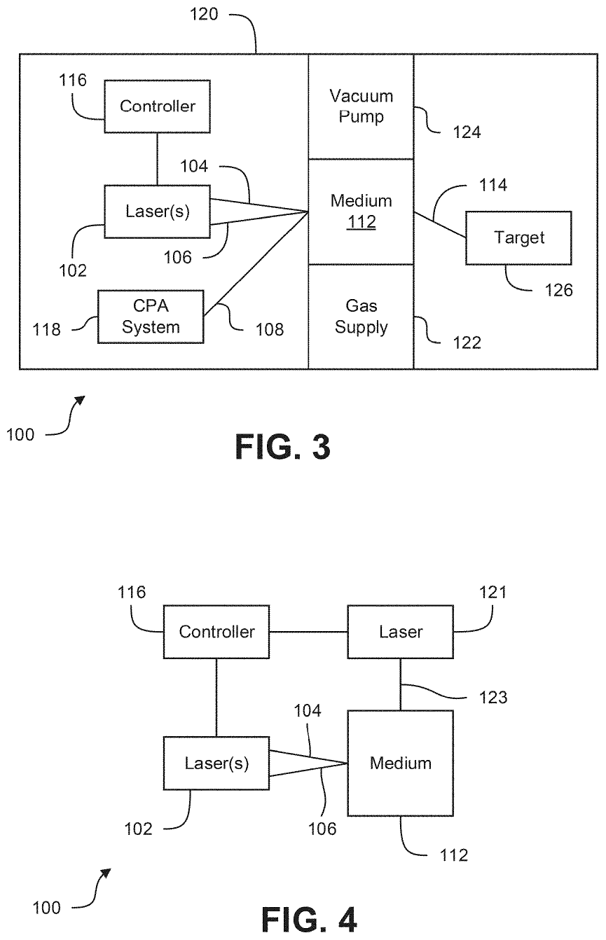

FIG. 3 shows an example embodiment of a system 100 for producing an optical element, such as a plasma grating. The system 100 can have a vacuum chamber 120, which can be configured to maintain a partial or substantial vacuum inside the vacuum chamber 120. A gas such as a gas jet or gas stream can be used as the non-linear medium 112. The system can have a gas supply 122 that can be configured to provide the gas jet or stream. The system can have a vacuum pump 124, which can extract the gas from the vacuum chamber 120. The inlet (e.g., gas supply 122) and the outlet (e.g., vacuum pump 124) for the gas medium 112 can be disposed on opposing sides of the vacuum chamber 120, or can face each other, to produce a finite gas jet or stream through the vacuum chamber 120. The gas jet can be a stream of gas flowing from the inlet (e.g., gas supply 122) to the outlet (e.g., vacuum pump 124). The gas jet or stream can have a thickness, which can be defined for example by the sizes and/or positions of the inlet (e.g., gas supply 122) and the outlet (e.g., vacuum pump 124) or other features of the system 100 or combination thereof. In some embodiments, a target 126 of the output laser beam 114 can be inside the vacuum chamber 120, although in other implementations, the output laser beam 114 can be output from the system 100. In some embodiments, hydrogen or helium, or any other suitable gas can be used for the medium 112. Other materials, such as liquids or solids could be used for the medium 112. For example, a thin layer of a solid material (e.g., a foil) can be used as the medium 112. The solid material can have a thickness of about 0.0005 mm, about 0.00075 mm, about 0.001 mm, about 0.0025 mm, about 0.005 mm, about 0.0075 mm, about 0.01 mm, about 0.025 mm, about 0.05 mm, about 0.075 mm, about 0.1 mm, about 0.25 mm, or more, or any values or ranges between any combination of these values, although other thicknesses could be used in some cases. The solid medium 112 can be in a vacuum (e.g., inside the vacuum chamber 120) in some cases.

The pump laser beams 104, 106 can ionize part of the solid medium, which can produce an expanding gas-density plasma, in some cases. The distribution of plasma can depend on the intensity of the light, so that the interference pattern between the pump beams 104, 106 can determine the distribution of the plasma. The system can include a support (e.g., a holder) configured to position the medium 112 (e.g., a plate or sheet or any suitable solid medium) relative to the one or more lasers 102 or laser beams so that the interference pattern can be formed at, on, and/or in the medium 112. The nonlinear medium 112 can be held in place by the support and the medium 112 may comprise a material (e.g., sheet, plate, foil, substrate, slab, etc.), which may be rigid or flexible and may be solid. The one or more lasers 102 and/or the optical element(s) 110 can be disposed or otherwise configured with respect to the support to direct the laser beams onto the nonlinear medium 112 so as to form a suitable interference pattern at that location. The optics that can be used to direct the laser beams to the nonlinear medium 112 (or the location relative to the support or supply where the nonlinear medium would be provided) can include one or more mirrors, lenses, prisms, beam splitters, beam combiners, or any other suitable optical components. In some implementations, the two pump beams comprise collimated beams incident at an angle with respect with each other to form an interference pattern corresponding to two tilted plane waves. Such an interference pattern, may comprise, for example, a plurality of parallel straight-line fringes. Suitable optics, such as lenses configured to provide collimation and/or mirrors to redirect the beam(s) may be employed, in some implementations to produce such beams. The system 100 can include a supply configured to provide the nonlinear medium 112. The supply can include a gas supply line, or a liquid supply line, a nozzle, or a flow cell (e.g., for transporting a liquid nonlinear medium 112), or transparent conduits, or chambers for example with transparent windows, or any other suitable device. The supply or support can position the medium 112 at the location where the interference pattern is formed. In some embodiments, a flow or stream of a liquid or gas can be formed between an inlet and an outlet, and the liquid or gas can be used as the nonlinear medium 112.

In some embodiments, the vacuum chamber 120 can be omitted. For example, the system 100 can operate in ambient air in some configurations. In some embodiments, the medium 112 can be a gas or other material with an ionization threshold that is lower than the ambient gas (e.g., air), so that the pump beams 104, 106 can ionize the medium 112 without ionizing other areas (e.g., air) in the system 100.

With reference to FIG. 4, in some embodiments, the system can include a laser 121 that can direct a third laser beam 123 through an area to produce a region of material (e.g., air) with increased energy to supply the medium 112. In some embodiments, one or more optical elements (not shown) can modify the laser beam 123 to distribute the energy of the laser beam 123 across the area of the medium 112. The laser beam 123 can propagate substantially perpendicular to one or more of the first pump beam 104, the second pump beam 106, and/or the probe beam 108. The laser 123 can propagate substantially perpendicular to the area where the first and second pump laser beams 104 and 106 substantially entirely overlap. The laser 123 can propagate substantially perpendicular to a direction midway between the directions of propagation for the first pump laser beam 104 and the second pump laser beam 106. For example, one or more lenses or other optical elements (not shown) can spread or otherwise distribute the laser beam 123 to affect an area that can be similar in size to the stream of gas medium in other embodiments. In some configurations, the energy of the constructive interference between the first and second pump beams 104, 106 together with the energy from the heater laser beam 123 can be sufficient to ionize the material (e.g., air) in the area of the medium 112, whereas areas that do not receive the laser beam 123 do not ionize even when there is constructive interference between the pump beams 104, 106. In some embodiments, ambient air that is exposed to the third laser beam 123 can be the medium 112.

In some embodiments, the pump laser beams 104 and 106 can pre-ionize the areas of constructive interference, such as by ionizing a small percentage (e.g., about 1% to 10%) of the air or other material. Then, the third laser beam 123 can deliver energy to further ionize the pre-ionized areas (e.g., to increase plasma density), such as by collision ionization. The third laser beam 123 can have insufficient power to not ionize regions that were not pre-ionized by the pump beams 104, 106 (e.g., areas of destructive interference and/or areas outside the laser beams 104 and 106). The third laser beam 123 can be a longer pulse than the pump laser beams 104, 106. The pump beams 104, 106 can be delivered to the area at a first time, the third laser beam 123 be delivered to the area at a second time that is after the first time (although some overlap is possible in some cases), and a probe beam can be delivered to the area at a third time that is after the second time (although some overlap is possible in some cases).

In some embodiments, the laser beam 123 can pre-ionize an area, such as by ionizing a small percentage (e.g., about 1% to about 10%) of the air or other material. The pre-ionized area can act as the medium 112. Then the pump beams 104, 106 can further ionize the pre-ionized areas that correspond to constructive interference between the pump beams 104, 106 (e.g., to increase plasma density), such as by collision ionization. The areas of destructive interference may not have enough intensity to further ionize the material, in some embodiments. The third laser beam 123 can be delivered to the area at a first time, the pump beams 104, 106 can be delivered to the area at a second time that is after the first time (although some overlap is possible in some cases), and a probe beam 108 can be delivered to the area at a third time that is after the second time (although some overlap is possible in some cases).

In some embodiments, the system 100 can include three pump laser beams. Two of the pump laser beams 104, 106 can interfere to produce an interference pattern, as discussed herein, and the third pump laser beam 123 can apply supplemental energy so that the areas of constructive interference can ionize the gas (e.g., ambient air). In some cases, laser beams 104, 106, and 123 can be delivered to the area at the same time, and the areas of constructive interference between beams 104 and 106, together with the additional energy of beam 123, can have sufficient intensity to ionize the material, while the areas of destructive interference do not have sufficient intensity to ionize the material, even with the energy of the beam 123. The beam 123 can have a different wavelength than the beams 104, 106, which can impede static interference between the beam 123 and the beams 104, 106. The intensity of the beam 123 can be lower than the intensity of the beams 104 and 106, which can reduce the interference effects that beam 123 may contribute to the resulting interference pattern. In some cases, the two pump laser beams 104, 106 can create pre-ionized regions (e.g., at locations of constructive interference), and the third pump laser beam (e.g., the heater beam 123) can ionize the pre-ionized regions (e.g., at a later time). In some configurations, the size of the formed optical element (e.g., the plasma grating) can be limited to the area of interaction between the three pump laser beams 104, 106, 123. In some implementations, the controller 116 can control the laser 121 that makes the third laser beam 123 as well as the one or more lasers 102 that make the laser beams 104 and 106, such as to control the timing of the laser beams 104, 106, 123. In some cases, the three pump laser beams 104, 106, and 123 can be provided by a single laser. For example, optical elements 110 can separate the 3 laser beams and redirect the laser beams 104, 106, and/or 123 so that they can provide the medium 112 and interference pattern, as discussed herein.

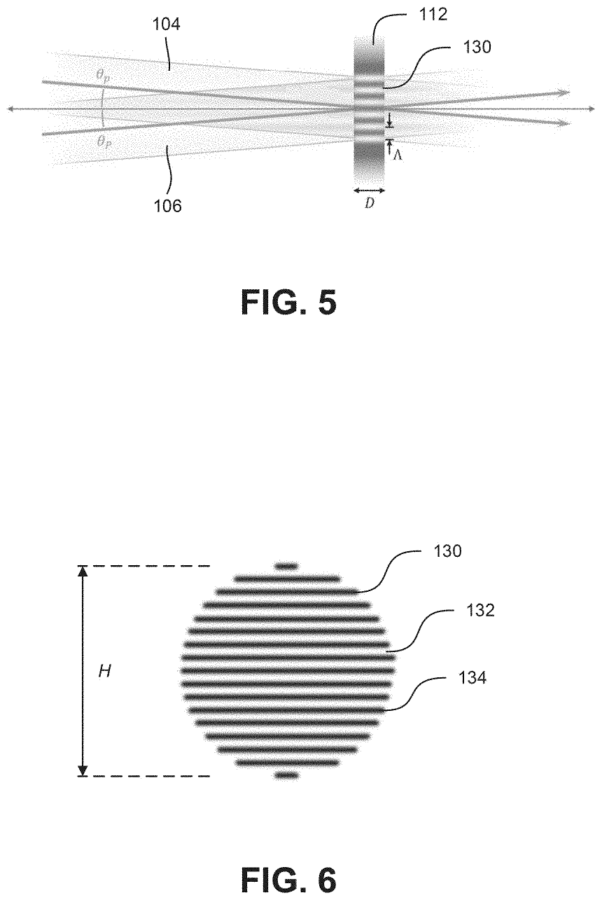

FIG. 5 shows an example of two pump beams 104, 106 producing an optical element 130 (e.g., a plasma grating) in a medium 112. The medium 112 can have a thickness D. In some implementations, the nozzle of the gas supply 122 can have an elongate shape that is shorter in the general direction of propagation of the laser beams 104, 106, and longer in the orthogonal direction. In some implementations multiple nozzles may be employed. In various implementations, the first pump laser beam 104 and the second pump laser beam 106 can be angled relative to each other. FIG. 5 shows an example of the first pump laser beam 104 and the second pump laser beam 106 intersecting at the medium 112. The medium can have a thickness of D (e.g., defined by the stream of gas, or nozzle, etc.) The first pump laser beam 104 and the second pump laser beam 106 can propagate in directions separated by an angle of 2θₚ. The first pump laser beam 104 can be angled in a first direction relative to a line normal to the medium 112 by and angle of θₚ. The second pump laser beam 106 can be angled in a second direction (e.g., opposite the first direction) relative to a line normal to the medium 112 by and angle of θₚ. The overlapping area of the first and second pump laser beams 104, 106 can increase as the laser beams 104, 106 approach the medium 112. The maximum overlap between the first and second pump laser beams 104, 106 can be inside the medium 112. The beams 104, 106 can diverge as they propagate away from the medium 112.

The pump laser beams 104, 106 can be substantially equal-power laser beams in some cases although their power and relative power may vary. The pump beams 104, 106 can propagate in a substantial vacuum except for the region of the gas medium (e.g., gas jet) 112, which can have thickness D. The pump laser beams 104, 106 can have substantially the same wavelength λₚ (or wavelength range) in some implementations. The probe laser beam 108 can have the same wavelength (or wavelength range) as the pump beams 104, 106 in some embodiments, but a different wavelength can be used for the probe beam 108 in some cases as well. The first pump laser beam 104 and the second pump laser beam 106 can both be plane wave beams in various implementations. Accordingly, the first pump laser beam 104 and the second pump laser beam 106 can both be substantially collimated in some cases.

Where the pump laser beams 104 and 106 cross and intersect the medium 112, they can create an interference pattern 128. The two pump beams 104, 106 can interfere everywhere that they overlap, but the interference pattern 128 is recorded where the beams 104, 106 overlap in the medium 112. FIG. 6 shows an example embodiment of an optical interference pattern created in the medium 112 by the two pump beams 104, 106. The interference pattern can have regions of constructive interference 132 with high intensity light (e.g., possibly higher light intensity than either of the pump beams alone), and regions of destructive interference 134 with low intensity light (e.g., possibly lower light intensity than either of the pump beams). The interference pattern 128 can produce a series of high intensity lines and low intensity lines. In some implementations the lines of high and low intensity are arranged along a single direction. These line may, for example, comprise straight lines as shown in FIG. 6 that are parallel to each other. Such an interference pattern can be produced by interfering two plane waves and can be produced by to collimated beams directed at an angle with respect to each other. The direction of the elongate or linear fringes can be determined by the orientation of the planar wavefronts with respect to each other and hence the direction that the pump laser beams 104 and 106 are angled with respect each other. The elongate or straight line fringes may be directed in a direction orthogonal to the plane of incidence of the two beams, as can be seen in FIG. 5. The number of fringes and their spacing can be determine by the amount of tilt between the planar waves or the angle, 2θₚ, between the two pump beams. The distance between bright lines or fringes (e.g., the grating period Λ, which can be referenced as the wavelength of the 1D intensity modulation) can be given by the equation Λ=λₚ/2*sin θₚ. Pump laser beams 104 and 106 that are directionally offset from each other along a vertical axis can produce an interference pattern 128 on the medium 112 with interference lines or fringes that are directed along the horizontal direction and extend periodically along the vertical direction, as shown in FIGS. 5 and 6. Accordingly, the interference pattern 128 can produce a stack of lines or fringes. As discussed above, this plurality of lines or fringes can produce a similarly patterned variation of index of refraction can form a diffraction grating, e.g., a linear diffraction grating, that can diffract light.

The medium 112 can be configured to have a variable index of refraction that depends on the intensity of light, so that the interference pattern 128 can modify the indices of refraction at different regions in the medium 112. With reference to FIG. 6, in some implementations the regions of constructive interference 132 can have a lower index of refraction than the regions of destructive interference 134, for example. The modulated index of refraction can be produced by a number of different mechanisms and in a number of different manners.

In some embodiments, spatially variant ionization (SVI) or spatially controlled ionization can produce the variations in the index of refraction in the medium 112. The medium 112 and the pump beams 104, 106 can be configured so that more of the medium 112 is converted into plasma at the regions of constructive interference 132, and less (or none) of the medium is converted into plasma at the regions of destructive interference 134. For example, in some implementations, only regions of constructive interference between the two pump beams 104, 106 have at sufficient intensity to ionize the gas medium 112. Although the medium 112 is discussed as being a neutral (e.g., non-ionized) gas, any suitable medium material could be used. By way of example, in some implementations, the index of refraction of the neutral gas medium can be greater than one (n>1), and the index of refraction of the plasma (e.g., ionized gas medium) can be less than one (n<1). Thus, as more of the gas medium in a region is ionized and converted into plasma, the index of refraction of that region can be reduced. Also, the distribution of the plasma (e.g., ionized gas) in the gas medium 112 (non-ionized gas) may be driven by light intensity, which can affect the indices of refraction across the interference pattern. For SVI, in some cases, the magnitude of the induced change in the index of refraction Δn can be about 10⁻² or about 1%. By way example, the difference between the index of refraction of the regions of constructive interference 132 and the regions of destructive interference 134 can be about 0.3, about 0.2, about 0.175, about 0.15, about 0.125, about 0.1, about 0.075, about 0.05, about 0.04, about 0.03, about 0.02, about 0.015, about 0.01, about 0.0075, about 0.005, about 0.004, about 0.003, about 0.002, about 0.001, about 0.00075, about 0.0005, about 0.00025, about 0.0001, or less, or any values or ranges between any of these values, although other amounts of index change can be implemented. The changes to the index of refraction can last for tens to hundreds of picoseconds, even when produce by femtosecond pump laser pulses. The modulated index of refraction can persist for about 1 picosecond, about 2 picoseconds, about 5 picoseconds, about 10 picoseconds, about 15 picoseconds, about 20 picoseconds, about 30 picoseconds, about 40 picoseconds, about 50 picoseconds, about 75 picoseconds, about 100 picoseconds, about 125 picoseconds, about 150 picoseconds, about 175 picoseconds, about 200 picoseconds, about 250 picoseconds, about 300 picoseconds, about 350 picoseconds, about 400 picoseconds, about 450 picoseconds, about 500 picoseconds, about 600 picoseconds, about 700 picoseconds, about 800 picoseconds, about 900 picoseconds, or more, or any values or ranges between these values, although other duration times can be produced.

In some embodiments, the variations in the index of refraction can be produced by ponderomotively-forced plasma density fluctuations. The ponderomotive force can impose a nonlinear force on a charged particle in an inhomogeneous oscillating electromagnetic field, and the ponderomotive force can cause the particle to move towards the area of the weaker field strength. Thus, the ponderomotive force can produce plasma density variations, and accompanying variations in the index of refraction, even if the medium is full-ionized gas (e.g., if all of the regions of constructive interference and destructive interference are plasma). In some embodiments, the regions of destructive interference 134 can have higher plasma density than the regions of constructive interference 132 due to the ponderomotive force, which can in some cases produce a lower index of refraction for the regions of destructive interference 134, as compared to the regions of constructive interference 132 (e.g., since vacuum has an index of refraction of 1). For the ponderomotive force, the magnitude of the induced change in the index of refraction An can be about 10⁻⁴. For example, the difference between the index of refraction of the regions of constructive interference 132 and the regions of destructive interference 134 can be about 0.4, about 0.3, about 0.2, about 0.1, about 0.075, about 0.05, about 0.025, about 0.01, about 0.0075, about 0.005, about 0.0025, about 0.001, about 0.00075, about 0.0005, about 0.0004, about 0.0003, about 0.0002, about 0.00015, about 0.0001, about 0.000075, about 0.00005, or less, or any values or ranges between any of these values, although other amounts of index change can be implemented. The changes to the index of refraction can last for tens of picoseconds. The modulated index of refraction can persist for about 1 picosecond, about 2 picoseconds, about 5 picoseconds, about 10 picoseconds, about 15 picoseconds, about 20 picoseconds, about 30 picoseconds, about 40 picoseconds, about 50 picoseconds, about 75 picoseconds, about 100 picoseconds, or more, or any values or ranges between these values, although other duration times can be produced. In some embodiments, the medium 112 can be a plasma even before the pump laser beams 104, 106 apply energy to the medium 112. In some embodiments, the medium and the pump laser beams 104, 106 can be configured so that the pump laser beams 104, 106 substantially fully ionize the medium. In some embodiments, ponderomotive electron forcing can drive electrons without (or before) moving the plasma ions, and the electron density variations can produce the differences in the indices of refraction.

In some embodiments, variations in the index of refraction can be produced in the medium 112 without plasma. For example, an entropy wave approach can produce changes in the index of refraction within the medium that come from density fluctuations in the gas based on the intensity of the light. In some cases, thermally-driven density fluctuations can produce a lower index of refraction at the regions of constructive interference 132 or relative high light intensity. For the approach using density fluctuations in gas, the magnitude of the induced change in the index of refraction Δn can be about 10⁻⁵. For example, the difference between the index of refraction of the regions of constructive interference 132 and the regions of destructive interference 134 can be about 0.00005, about 0.00004, about 0.00003, about 0.00002, about 0.000015, about 0.00001, about 0.0000075, about 0.000005, or less, or any values or ranges between any of these values, although other amounts of index change can be implemented. The changes to the index of refraction can last for hundreds of nanoseconds. For example, the modulated index of refraction can persist for about 25 nanoseconds, about 50 nanoseconds, about 75 nanoseconds, about 100 nanoseconds, about 150 nanoseconds, about 200 nanoseconds, about 250 nanoseconds, about 300 nanoseconds, about 400 nanoseconds, about 500 nanoseconds, about 600 nanoseconds, about 700 nanoseconds, about 800 nanoseconds, about 900 nanoseconds, or more, or any values or ranges between these values, although other duration times can be produced. Accordingly, in some embodiments, the optical element (e.g., diffractive lens) can be produced without plasma.

The optical element (e.g., plasma grating) can persist after the end of the pump laser beams 104, 106 for a time that is longer than the pulses of the pump laser beams 104, 106, such as about 2 times longer, about 5 times longer, 10 times longer, about 25 times longer, about 50 times longer, about 75 times longer, about 100 times longer, about 150 times longer, about 250 times longer, about 500 times longer, about 750 times longer, about 1,000 times longer, times longer, about 1,250 times longer, about 1,500 times longer, about 1,750 times longer, about 2,000 times longer, about 2,500 times longer, about 3,000 times longer, about 4,000 times longer, about 5,000 times longer, about 7,500 times longer, about 10,000 times longer, about 15,000 times longer, about 25,000 times longer, about 50,000 times longer, about 100,000 times longer, about 150,000 times longer, about 200,000 times longer, or more, or any values or ranges between any combination of these values, although other configurations are possible.

Moreover, in various implementations the optical element (e.g., plasma grating) can persist long enough after the end of the pump laser beams 104, 106 (e.g., after the pump laser beam pulse), that a laser pulse of the probe beam 108 can be delivered to the optical element 130 in the medium 112 after the end of the pulses of the first and second pump laser beams 104, 106 by a delay time, which delay can be about 1 picosecond, about 5 picoseconds, about 10 picoseconds, about 25 picoseconds, about 50 picoseconds, about 75 picoseconds, about 100 picoseconds, about 150 picoseconds, about 200 picoseconds, about 250 picoseconds, about 300 picoseconds, about 350 picoseconds, about 400 picoseconds, about 450 picoseconds, about 500 picoseconds, about 600 picoseconds, about 700 picoseconds, about 800 picoseconds, about 900 picoseconds, about 1,000 picoseconds, or more, or any values or ranges between any combination of these values, although other configurations are possible. The probe beam 108 can be a femtosecond laser pulse or a picosecond laser pulse, although any suitable pulse duration can be used. In some implementations, the pulse of the probe beam 108 can be longer than the pulses of the pump beams 104, 106, such as about 2 times longer, about 5 times longer, 10 times longer, about 25 times longer, about 50 times longer, about 75 times longer, about 100 times longer, about 150 times longer, about 250 times longer, about 500 times longer, about 750 times longer, about 1,000 times longer, or more, or any values or ranges between any combination of these values, although other configurations are possible. In some embodiments, the probe beam 108 can have a shorter duration than one or both of the pump beams 104, 106. For example, the pump beams 104, 106 can be 100 ns long in some cases, and the probe beam could be a 10 fs pulse. Various different interference patterns can be created by overlapping the first and second pump laser beams 104, 106 at the medium 112. As discussed above, in some implementations, an interference pattern comprising a linear fringe pattern comprising a plurality of straight line fringes can be formed by interfering two planar wavefronts such as by interfering two collimated pump beams 104, 106. Other arrangements and other fringe patterns, however, are possible. In some embodiments, the interference pattern 128 can be used to produce a diffraction grating, which can be used as part of a CPA system 118, as shown in FIGS. 1 and 3. The embodiments of FIGS. 2 and 4 can also include a CPA system 118 for producing an amplified laser pulse, as discussed herein. In some cases, the diffraction grating optical element 130 can be used for other purposes, and the CPA system 118 can be omitted.

The optical element 130 (e.g., plasma grating) can have a thickness D, which can be smaller than the height H of the optical element 130 (e.g., plasma grating). In some cases, the height H of the optical element 130 can be defined by the diameter of the overlapping pump laser beams 104, 106. The pump laser beams 104, 106 can overlap each other by at least 75%, at least about 80%, at least about 85%, at least about 90%, at least about 95%, or about 100% or any range between any of the values at the medium 112 although the overlap can possibly be smaller. The thickness D of the transmission grating 130 through which the probe beam 108 propagates can be smaller than the height H, smaller than a diameter(s) of one or both of the pump laser beams 104, 106, and/or smaller than a diameter of the probe beam 108.

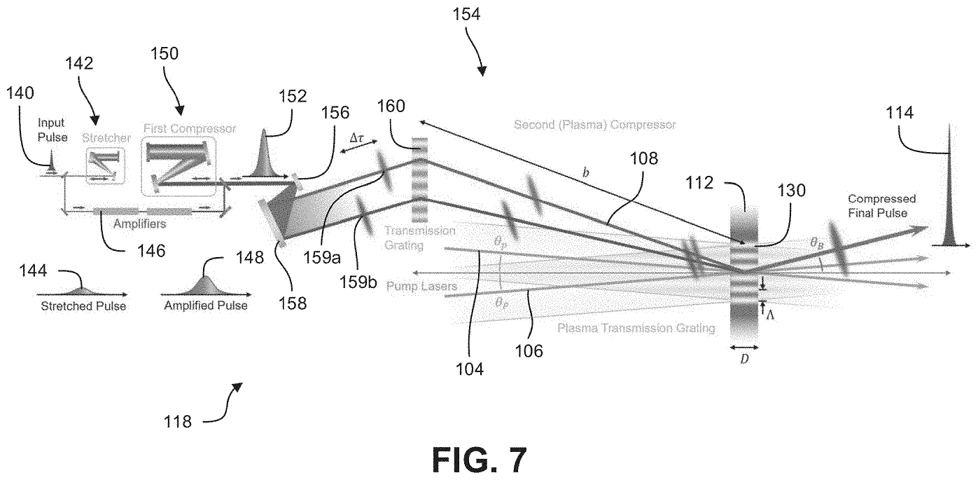

FIG. 7 shows an example embodiment of a chirped pulse amplification (CPA) system 118 that uses the optical element 130 (e.g., the plasma grating) formed at the medium 112. The CPA system 118 can generate or receive an input laser pulse 140. The input laser pulse can be a femtosecond laser pulse, although picosecond laser pulses, or any other suitable type of laser pulse could be used and any suitable pulse width or duration can be used. The input pulse can have a pulse width or duration, for example, of about 5 fs, about 10 fs, about 15 fs, about 20 fs, about 25 fs, about 30 fs, about 35 fs, about 40 fs, about 50 fs, about 55 fs, about 50 fs, about 55 fs, about 60 fs, about 65 fs, about 70 fs, about 75 fs, about 85 fs, about 100 fs, about 125 fs, about 150 fs, about 175 fs, about 200 fs, about 250 fs, about 300 fs, about 400 fs, about 500 fs, about 750 fs, about 1000 fs, about 1.25 ps, about 1.5 ps, about 1.75 ps, about 2 ps, about 2.5 ps, about 3 ps, about 5 ps, about 7.5 ps, about 10 ps, about 15 ps, about 25 ps, about 50 ps, about 75 ps, about 100 ps, or more, or any values or ranges therebetween, although values outside these ranges are possible. In some embodiments, the input laser pulse can be between about 10 fs and about 50 fs. The CPA system 100 can include a laser, such as a femtosecond seed laser, or the input laser pulse can be received from an outside system or external seed laser.

The CPA system can have a laser pulse stretcher 142, which can be configured to receive the input laser pulse 140 and to stretch the laser pulse to provide a stretched laser pulse 144, which can have a pulse width or duration that is longer than the pulse width or duration of the input pulse 140. For example, the stretcher 142 can stretch an input pulse of about 10 fs so that the stretched pulse 144 has a pulse width or duration of about 1 ns, although the stretcher 142 can perform any suitable amount of stretching. The stretched pulse 144 can have a pulse width of duration of about 500 fs, about 750 fs, about 1 ps, about 10 ps, about 50 ps, about 100 ps, about 250 ps, about 500 ps, about 700 ps, about 800 ps, about 900 ps, about 1 ns, about 1.1 ns, about 1.2 ns, about 1.3 ns, about 1.5 ns, about 1.75 ns, about 2 ns, about 3 ns, about 5 ns, about 7.5 ns, about 10 ns, about 15 ns, about 20 ns, about 25 ns, about 50 ns, about 100 ns, or more, or any values or ranges therebetween, although other values could be used in some cases.

Any suitable type of laser pulse stretcher 142 can be used. The stretcher 142 can be configured to chromatically stretch the laser pulse 140. For example, different wavelengths of light may be provided with different optical path length to delay certain spectral components with respect to others. For example, the stretcher 142 can be configured to provide a shorter optical path length for light of longer wavelengths and a longer optical path length for light of shorter wavelengths. The stretched pulse 144 can have the longer wavelength light at the front and the shorter wavelength light at the back of the pulse. Other configurations, however, are possible. For example, the longer wavelengths of light can have a longer optical path length than the shorter wavelengths of light, so that the pulse is chromatically stretched in the other direction with the longer wavelengths of light lagging behind the shorter wavelengths of light. The peak power or intensity of the light can be reduced corresponding to the amount that the pulse was stretched.

The stretcher 142, for example, can have a first grating that is configured to diffract the light in the input laser pulse 140 so that different wavelengths of light propagate away from the first grating in different angles. As a result, of this angular dispersion, different wavelengths of light propagate along different optical paths and may be provided with different optical path lengths to delay certain spectral components with respect to others. The stretcher can have a second grating positioned to receive light subjected to angular dispersion and redirect the light (e.g., by diffraction) towards a reflector. The second grating can also diffract different wavelengths by different amounts (e.g., at different angles), in some implementations, to counter the effect of the first grating. The second grating may, for example, offset the diffraction angles introduced by the first grating, for example, such that the different spectral components are directed along the same angle. In FIG. 7, for example, the second grating is shown redirecting the light of different wavelengths by different angles to generally collimate the light of different wavelengths. The reflector can reflect the light and direct it back to the second grating of the stretcher, which can diffract the light and direct it to the first grating of the stretcher. This diffraction is wavelength dependent, the second grating again introducing angular dispersion. Different wavelengths are diffracted different amounts, e.g., at different angles. As a result, different wavelengths of light may again be provided with different optical path lengths to delay certain spectral components with respect to others. This light is received by the first diffraction grating, which can again diffract different wavelengths different amount (e.g., at different angles) so as to counter the effect of the second grating. The first grating may, for example, offset the diffraction angles introduced by the second grating, for example, such that the different spectral components are directed along the same angle. The optics of the stretcher 142 can, thus, be configured so that the returning light of different wavelengths converges on the first grating from different angles and is diffracted from that location so that the light of different wavelengths propagates away from the first grating at substantially the same angle. The stretcher 142 can thereby be configured so that the different wavelengths of light have different optical path lengths from the first grating, to the second grating, to the reflector, back to the second grating, and then to the first grating, to chromatically stretch the laser pulse. The stretcher can split the light of the laser pulse into beams or a distribution of different wavelengths of light, direct the different wavelengths of light along optical paths of different path lengths, and then combine the light of different wavelengths into a single beam of light that is chromatically stretched with some spectral components delayed in comparison to other spectral components.

Other configurations can be used for the pulse stretcher 142. For example, the reflector can be omitted, and the stretcher 142 can include four gratings. The first grating can introduce angular dispersion by diffracting the light of the input laser pulse of different wavelengths at different angles. The second grating can also introduce counter-acting angular dispersion redirecting the light of different wavelengths by different amounts to generally collimate the light and direct it to the third grating. The third grating can introduce angular dispersion thereby diffracting the light of different wavelengths at different angles so that the light of different wavelengths converges spatially at the fourth grating, but with different wavelengths of light reaching the fourth grating at different times due to the chromatic stretching. The fourth grating can receive the light of different wavelengths from different approach angles and via counteracting angular dispersion can diffract the light so that the light of different wavelengths propagates away from the fourth grating at substantially the same angle, with the light recombined into a single beam that is chromatically stretched by having some spectral components delayed with respect to other spectral components. Other configuration and designs, however, are possible.

In some embodiments, one or more prisms can be used in place of one or more of the gratings of the stretcher. The one or more prisms can refract the light of different wavelengths by different amounts as a result of angular dispersion. In some configurations, the stretcher 142 can include one or more lenses, which can be used for example to direct the light between the first and second gratings. In some embodiments, one or more fiber optic components can be used, such as fiber Bragg gratings, such as to perform a wavelength-dependent operation on the light (e.g., for chromatic pulse stretching). Any suitable configuration of laser pulse stretcher 142 can be used.

The laser pulse stretcher can stretch the pulse and/or reduce the peak power or light intensity of the laser pulse by a factor of about 100, about 200, about 300, about 500, about 750, about 1000, about 1500, about 2000, about 3000, about 5000, about 7000, about 8000, about 9000, about 10,000, about 11,000, about 12,000, about 13,000, about 15,000, about 17,500, about 20,000, about 25,000, about 30,000, about 40,000, about 50,000, about 75,000, about 100,000, or more, or any values or ranges therebetween, although other values could be used in some cases.

The CPA system 118 can have one or more amplifiers 146 configured to receive and amplify the stretched pulse 144 to produce an amplified stretched pulse. In some cases, multiple amplifiers can be used, or a multi-stage amplifier can be used. A first amplifier or stage can receive the stretched pulse and provide a first amplification to provide a partially amplified pulse that is delivered to a second amplifier or stage, which can apply a second amplification to provide the amplified stretched pulse 148. Additional amplifiers or stages (e.g., 3, 4, 5, or more) could be used in some cases, or a single amplifier or stage can be used. The one or more amplifiers 146 can increase the peak power or light intensity, such as by a factor of about 1,000, about 2,000, about 3,000, about 5,000, about 7,500, about 10,000, about 15,000, about 20,000, about 30,000, about 40,000, about 50,000, about 75,000, about 100,000, about 150,000, about 250,000, about 500,000, about 750,000, about 1,000,000, or more, or any values or ranges therebetween, although other values could be used in some configurations. The one or more amplifiers 146 can increase the peak power without substantial change to the pulse width or duration of the pulse. The amplified stretched pulse 148 can have much more energy than the original input pulse 140, but because the energy is spread out over the stretched pulse the peak power or light intensity can be low enough that solid state optical elements can be used on the pulse 148. In some cases, the peak power or light intensity of the amplified stretched pulse 148 can be about the same as, or more than, the input pulse 140.

The CPA system 118 can have a first laser pulse compressor 150, which can have features and operations similar to the stretcher 142, except that the compressor 150 can operate to compress, rather than stretch, the pulse of light. The first compressor 150 can be configured to provide a partially compressed amplified laser pulse 152, which can have a pulse width or duration that is less than that of the stretched pulse 144. The partially compressed amplified laser pulse 152 output by the first compressor 150 can have a pulse width or duration that is longer than that of the input pulse 140. In some embodiments, a second compressor 154 can further compress the pulse resulting in an even shorter pulse width, as discussed herein. For example, the first compressor 150 can compress a pulse 148 having a pulse width of about 1 ns to have a pulse width between about 1 ps and 10 ps, although other configurations can be used. The partially compressed pulse 152 can have a pulse width or duration of about 200 fs, about 300 fs, about 400 fs, 500 fs, about 600 fs, about 700 fs, about 800 fs, about 900 fs, about 1 ps, about 1.1 ps, about 1.2 ps, about 1.3 ps, about 1.5 ps, about 1.75 ps, about 2 ps, about 2.5 ps, about 5 ps, about 7.5 ps, about 10 ps, about 12.5 ps, about 15 ps, about 17.5 ps, about 20 ps, about 25 ps, about 50 ps, about 75 ps, about 100 ps, about 150 ps, about 200 ps, about 300 ps, about 400 ps, about 500 ps or more, or any values or ranges therebetween, although other values could also be used.

Any suitable type of laser pulse compressor 150 can be used. The compressor 150 can be configured to chromatically compress the laser pulse 148. For example, different wavelengths of light may be provided with different optical path length to delay certain spectral components with respect to others so as to cause different spectral components to overlap each other temporally reducing the width of the pulse. Accordingly, in some implementations, the compressor 150 can be configured to at least partially undo the chromatic stretching that was applied by the stretcher 142. In some designs, for example, the compressor 150 can be configured to provide a longer optical path length for light of longer wavelengths and a shorter optical path length for light of shorter wavelengths (e.g., opposite of the stretcher 142). The partially compressed pulse 152 can have the longer wavelength light at the front and the shorter wavelength light at the back of the pulse, similar to the stretched pulse 144, except that the different wavelengths of light are less spread apart in the partially compressed pulse 152. Other configurations are possible. For example, in some cases, the compressor 152 could transition the light through full compression to partially stretch the light in the opposite chromatic direction, so that the partially compressed pulse output from the compressor has the shorter wavelength light ahead of the longer wavelength light (e.g., opposite of the light pulse received by the compressor 150). In some embodiments, the longer wavelengths of light can have a longer optical path length than the shorter wavelengths of light, for example, if that is the configuration opposite of the stretcher 142. The peak power or intensity of the light can be increased corresponding to the amount that the pulse was compressed, which can be seen in FIG. 7 by comparison of stretched amplified pulse 148 to the partially compressed pulse 152.

The first compressor 150 can have a first grating that is configured to diffract the light of the amplified stretched pulse 148 so that light of different wavelengths propagates at different angles due to angular dispersion of the grating. As a result, different wavelengths of light propagate along different optical paths and may be provided with different optical path lengths to delay certain spectral components with respect to others. The first compressor 150 can have a second grating positioned to receive the light subjected to the angular dispersion of the first grating and redirect the light (e.g., by diffraction) towards a reflector. The second grating can also diffract different wavelengths by different amounts (e.g., at different angles), in some implementations, to counter the effect of the first grating. The second grating may, for example, offset the diffraction angles introduced by the first grating, for example, such that the different spectral components are directed along the same angle. In FIG. 7, for example, the second grating is shown redirecting the light of different wavelengths by different angles to generally collimate the light of different wavelengths. The reflector can reflect the light and direct it back to the second grating of the compressor 150, which can diffract the light and direct it to the first grating of the first compressor. This diffraction is wavelength dependent, the second grating again introducing angular dispersion. Different wavelengths are diffracted different amounts, e.g., at different angles. As a result, different wavelengths of light may again be provided with different optical path lengths to delay certain spectral components with respect to others. This light is received by the first diffraction grating, which can again diffract different wavelengths different amount (e.g., at different angles) so as to counter the effect of the second grating. The first grating may, for example, offset the diffraction angles introduced by the second grating, for example, such that the different spectral components are directed along the same angle. The optics of the first compressor 150 can thus be configured so that the returning light of different wavelengths converges on the first grating from different angles and is diffracted from that location so that the light of different wavelengths propagates away from the first grating at substantially the same angle. The first compressor 150 can thereby be configured so that the different wavelengths of light have different optical path lengths from the first grating, to the second grating, to the reflector, back to the second grating, and then to the first grating, to partially chromatically compress the laser pulse. The first compressor 150 can split the light of the laser pulse into beams, or a distribution, of different wavelengths of light, direct the different wavelengths of light along optical paths of different path lengths, and then combine the light of different wavelengths into a single beam of light with some spectral components delayed in comparison to other spectral components. The result is that some of the spectral components temporally overlap or are temporally closer other spectral components, reducing the temporal width or duration of the pulse 152.

Other configurations can be used for the pulse compressor 150. For example, the reflector can be omitted, and the compressor 150 can include four gratings. The first grating can receive the different wavelengths of light of the amplified stretched pulse 148 at different times (e.g., due to the chromatic stretching of the pulse), and the first grating can diffract the light of different wavelengths at different angles as a result of angular dispersion. The second grating can redirect the light of different wavelengths by different amounts, e.g., at different angles, to offset the angular dispersion of the first grating to generally collimate the light and direct it to the third grating. The third grating can, as a result of angular dispersion, diffract the light of different wavelengths at different angles so that the light of different wavelengths converges spatially towards the fourth grating. In some embodiments, the different wavelengths of light can reach the fourth grating at different times (e.g., since the pulse 152 is only partially compressed), but with less spread than the pulse 148 that was input into the first compressor 150. The fourth grating can receive the light of different wavelengths from different approach angles and can, via counter-acting dispersion, diffract the light so that the light of different wavelengths propagates away from the fourth grating at substantially the same angle, with the different spectral component superimposed in the beam. Additionally, some spectral components are delayed with respect to other spectral components such that spectral components temporally overlap or are temporally closer together. Nevertheless, in some cases, the pulse can still remain partially chromatically stretched. Other configuration and designs, however, are possible.

In some embodiments, one or more prisms can be used in place of one or more of the gratings of the compressor 150. The one or more prisms can refract the light of different wavelengths by different amounts as a result of angular dispersion. In some configurations, the compressor 150 can include one or more lenses, which can be used for example to direct the light between the first and second gratings. In some configurations, the compressor 150 can include one or more lenses and/or mirrors or reflectors, which can be used for example to direct the light between gratings. In some cases, one or more fiber optic components can be used, such as fiber Bragg gratings, such as to perform a wavelength-dependent operation on the light (e.g., for partial chromatic pulse compression). Any suitable configuration of laser pulse compressor 150 can be used.

The first compressor 150 can compress the pulse and/or increase the peak power or light intensity of the laser pulse by a factor of about 10, about 20, about 30, about 50, about 75, about 100, about 150, about 200, about 250, about 500, about 750, about 1,000, about 1,250, about 1,500, about 1,750, about 2,000, about 2,500, about 3,000, about 3,500, about 4,000, about 4,500, about 5,000, about 6,000, about 7,000, about 8,000, about 9,000, about 10,000 or more, or any values or ranges therebetween, although other values could be used in some cases.

The CPA system 118 can have a second laser pulse compressor 154. The second compressor 154 can be configured to output a compressed amplified laser pulse 114, which can have a pulse width or duration that is less than that of the stretched pulse 144 and less than the partially compressed pulse 152. The laser pulse 114 output by the second compressor 154 can have a pulse width or duration that is about the same as that of the input pulse 140, or not more than about 5%, about 10%, about 15%, about 20%, or about 25% above or greater than the pulse width of the input pulse 140, or any values or ranges therebetween, although other values could be used in some cases. In some embodiments, a second compressor 154 can further compress the pulse 148 output from the first compressor 150, as discussed herein. For example, the second compressor 154 can compress the pulse 152 to a pulse width of about 5 fs, about 10 fs, about 15 fs, about 20 fs, about 25 fs, about 30 fs, about 35 fs, about 40 fs, about 50 fs, about 55 fs, about 50 fs, about 55 fs, about 60 fs, about 65 fs, about 70 fs, about 75 fs, about 85 fs, about 100 fs, about 125 fs, about 150 fs, about 175 fs, about 200 fs, about 250 fs, about 300 fs, about 400 fs, about 500 fs, about 750 fs, about 1000 fs, about 1.25 ps, about 1.5 ps, about 1.75 ps, about 2 ps, about 2.5 ps, about 5 ps, about 7.5 ps, about 10 ps, about 15 ps, about 20 ps, about 30 ps, about 40 ps, about 50 ps, about 70 ps, about 100 ps or more, or any values or ranges therebetween, although other configurations are also possible.

The second compressor 154 can be configured to chromatically compress the laser pulse 152. For example, different wavelengths of light may be provided with different optical path length to delay certain spectral components with respect to others so as to cause different spectral components to overlap each other temporally reducing the width of the pulse. Accordingly, in some implementations, the compressor 150 can be configured to at least partially undo the chromatic stretching that was applied by the stretcher 142. In some designs, for example, the compressor 154 can be configured to provide a longer optical path length for light of longer wavelengths and a shorter optical path length for light of shorter wavelengths (e.g., opposite of the stretcher 142). The output pulse 114 can have the chromatic distribution of light (e.g., the “chirp) substantially removed or reduced from the pulse by the compressor 154. For example, the output pulse 114 can have light of different wavelengths each distributed throughout the pulse (e.g., similar to the input pulse 140), rather than a distribution of higher to lower wavelengths of light across the pulse. In some embodiments, the output pulse 114 can still have the longer wavelength light at the front and the shorter wavelength light at the back of the pulse, similar to the stretched pulse 144, except that the different wavelengths or spectral components of light are compressed into the shorter pulse width or duration, as discussed herein. Other configurations are possible. For example, the output pulse 114 could have the shorter wavelength light ahead of the longer wavelength light (e.g., if the direction of chromatic distribution was switched by the first compressor 150). In some embodiments, the longer wavelengths of light can have a longer optical path length than the shorter wavelengths of light, if that is the configuration that would compress the pulse 152. The peak power or intensity of the light can be increased corresponding to the amount that the pulse was compressed, which can be seen in FIG. 7 by comparison of partially compressed pulse 152 to the compressed pulse 114. The peak power or intensity of the light for pulse 152 can still be low enough that some solid state optical elements can be used on the pulse 152 in various designs.

The second compressor 150 can have a first grating that is configured to diffract the light of the amplified stretched pulse 148 so that light of different wavelengths propagates at different angles away from the first grating 156 due to angular dispersion of the grating. The second compressor 154 can have a second grating 158 positioned to receive the light subjected to the angular dispersion of the first grating and redirect the light (e.g., by diffraction) towards a third grating 160. The first grating 156 and the second grating 158 (as well as the gratings of the stretcher 142 and the first compressor 150) can be reflective gratings, but in some embodiments transmissive gratings can be used. The first grating 156 can have angular dispersion such that different wavelengths of light incident thereon are directed to different portions of the second grating 158. The different wavelengths of light can impinge on the second grating 158 at different angles and at different locations. The second grating 158 can redirect the different wavelengths of light by different angles (e.g., by diffraction and the angular dispersion of the diffraction), and the second grating 158 can be oriented so that the different redirecting angles provided by the second granting 158 substantially undo the different redirecting angles imposed by the first grating 156. Thus, the light output from the second grating 158 can be substantially collimated, but with the different wavelengths of light spread out laterally in some implementations. In FIG. 7, the higher wavelength light 159a can be diffracted from one end or portion of the grating 158 (e.g., the upper portion in FIG. 7), while the lower wavelength light 159b can be diffracted from the other end or portion of the grating 158 (e.g., the lower portion in FIG. 7). The higher wavelength light 159a and the lower wavelength light 159b can propagate away from the second grating 158 along substantially parallel optical paths, but offset laterally from each other, with a distribution of other wavelengths therebetween and propagating substantially parallel thereto. The second grating 158 can redirect the light of different wavelengths by different angles in some implementations to generally collimate the light of different wavelengths as it propagates toward the third grating 160. The different optical paths for the respective different spectral components can have different optical path lengths introducing optical delay between the respective spectral components. The delay of some of the spectral components with respect to other spectral components may cause spectral components to temporally overlap or be temporally closer to other spectral components such that the pulse duration is reduced and the pulse compressed. The higher wavelength light 159a can still be ahead of the lower wavelength light 159b, such as by the distance Δτ (e.g., because of the chromatic spreading, for example, produced by the stretcher 152 that was not undone by the first compressor 150 or introduced in other portions of the system such as by the first and second gratings 156, 158 of the second compressor 154).

The second compressor 154 can have a third grating 160. The third grating 160 can be a transmission grating, although a reflective grating could be used in some embodiments. The third grating 160 can be positioned to diffract the light to redirect the light toward the fourth grating 130. Different wavelengths are diffracted different amounts, e.g., at different angles as a result of angular dispersion associated with the third grating 160. As a result, different wavelengths of light may be provided with different optical paths having different optical path lengths to delay certain spectral components with respect to others. The delay of some of the spectral components with respect to other spectral components may cause spectral components to temporally overlap or be temporally closer to other spectral components such that the pulse duration is reduced and the pulse compressed. FIG. 7, for example, illustrates how the different spectral components 159a and 159b between the second and third gratings 158, 160 of the second compressor 154 are closer together after being diffracted by the third grating and propagating some distance. The delay between these spectral components is shown as reduced. This reduced differential delay results in a shorter duration, more compressed optical pulse.

The third grating 160 can be configured so that it redirects the light of different wavelengths by different amounts so that the light of different wavelengths converges as it propagates towards the fourth grating 130. The third grating 160 may be position and oriented, and the fourth grating 130 can be positioned, so that the light of different wavelengths converges angularly at the fourth grating 130, as can be seen in FIG. 7.

The fourth grating 130 has associated therewith angular dispersion. This angular dispersion is configured to cause diffraction of different wavelengths of light from the third grating 160 by different amounts (e.g., at different angles) so as to counter and/or offset the convergence of the different spectral components introduced by the third grating 160. The fourth grating 130 may, for example, counter and/or offset the diffraction angles introduced by the second grating, for example, such that different spectral components are directed more along the same angle. The different spectral components travelling along the same direction and temporally spaced closed together produce the compressed pulse 114 such as shown in FIG. 7 at the output of the second compressor 154. Accordingly, in various implementations, the fourth grating 130 has a grating period or periodicity, A, configured to diffract the different wavelength or spectral components at different angles as a result of the angular dispersion of the grating so as to cause the different spectral components to be direct more in the same direction than the wavelengths or spectral components from the laser light incident thereon. In various implementations, the resultant directions of the various spectral components are the same. As illustrated in FIG. 7, for example, the spectral components together propagate at an angle θ_{B} with respect to a normal to the fourth grating 130. Other variations and configurations, however, are possible.

As discussed above, the optical path length from the first grating 156, to the second grating 158, to the third grating 160, to the fourth grating 130 of the second compressor 154 can be different for light of different wavelengths. For example, the path length for the higher wavelength light 159a can be longer than for the lower wavelength light 159b, which can permit the lower wavelength light 159b to at least partially catch up to the higher wavelength light 159a. The different wavelengths of light can converge longitudinally as well as laterally as it approaches the fourth grating 130. The compressor 154 can be configured (e.g., with the fourth grating 130 displaced away from the third grating 160 by a distance b) so that the light is substantially fully chromatically compressed at or in the medium 112 (e.g., when the light is diffracted by the fourth grating 130), so that the output pulse 114 is created with the final pulse width, as discussed herein. In some embodiments, the pulse 114 may not be fully chromatically compressed, but the compression can be sufficient to produce the laser pulse with a short pulse width and a high intensity, as discussed herein. The second compressor 154 can split the light of the laser pulse into beams, or a distribution, of different wavelengths of light, direct the different wavelengths of light along optical paths of different lengths (e.g., to achieve the compression), and then combine the light of different wavelengths into a single beam of light to produce the output pulse 114. In various implementations such as illustrated in FIG. 7, the output beam of light can propagate away from the medium 112 or grating 130 at an angle θ_{B} relative to a line normal to the medium 112 or grating 130.

In various designs, the fourth grading 130 can comprise a diffraction grating formed in the medium by the interference pattern between the first and second pump laser beams 104 and 106, as discussed herein. In some embodiments, the fourth grating 130 can be a plasma grating (e.g., a plasma volume transmission grating) such as, for example, described above. As the pulse is compressed the peak power or intensity increases and the final grating 130 can be exposed to substantially the fully compressed peak power or intensity of the final laser pulse 114. In some embodiments, that peak power or intensity can damage or destroy conventional or solid-state optical elements. The plasma grating can be used for the final grating 130 because the plasma grating has a much higher damage tolerance for high intensity light. In some embodiments, the damage threshold of the plasma grating 130 can be orders-of-magnitude higher than transitional reflection gratings.

Other configurations can be used for the second pulse compressor 154. For example, one or more of the first, second, and third gratings 156, 158, and 160 can be omitted, in some embodiments. In some cases, one or more of the first, second, and third gratings 156, 158, and 160 can comprise a plasma grating such as possible a plasma transmission grating. In some implementations, such plasma gratings can diffract the light of different wavelengths by different amounts to introduce delay between spectral components and/or to direct the different spectral components along different or same directions and/or optical paths. In some cases, in place of any one of the gratings 156, 158, and 160, one or more prisms can be used to introduce angular dispersion, such as to direct the light to the plasma grating 130. The one or more prisms can refract the light of different wavelengths by different amounts to introduce delay between spectral components and/or to direct the different spectral components along different directions and/or optical paths. In some configurations, the compressor 154 can include one or more lenses and/or mirrors or reflectors, which can be used for example to direct the light between gratings. For example, the first grating 156 can apply angular dispersion to the light and direct the light to a lens or curved reflector, which can focus the light of different wavelengths onto the grating 130. Any suitable configuration of laser pulse compressor 154 can be used.

The second compressor 154 can compress the pulse and/or increase the peak power or light intensity of the laser pulse by a factor of about 5, about 10, about 25, about 50, about 75, about 100, about 125, about 150, about 175, about 200, about 250, about 275, about 300, about 350, about 400, about 450, about 500, about 600, about 700, about 800, about 900, about 1,000, about 1,250, about 1,500, about 1,750, about 2,000, about 3,000, about 5,000, about 7,500, about 10,000 or more, or any values or ranges therebetween, although other values could be used in some cases. In some embodiments, the first compressor 150 can apply a larger compression factor than the second compressor 154, although the inverse configuration could also be used.

In some embodiments, a reflective plasma grating can be used, such as a plasma mirror where a grating structure is formed on an ionized solid surface. However, the transmissive plasma grating 130 can have advantages over a reflective plasma grating. For example, the transmissive plasma grating 130 can avoid problems with plasma blowoff from the target making it difficult to form a flat surface. Also, a reflective plasma can use solid-density targets, which can have repetition-rate limits, debris issues, and experimental complexity.

The pulse compressor 154 can operate as a result of the angular dispersion (e.g., by solid-state gratings) and subsequent propagation through free space, as opposed to performing compression while the light propagates through a plasma. The compression occurs whiles the light of different wavelengths propagates through the ambient space outside the plasma optical element (e.g., the plasma grating 130). For example, as the light of different wavelengths approach the plasma grating 130, the different path lengths can have the effect of compressing the laser pulse (e.g., outside the plasma element). This approach can be less sensitive than compressing the laser pulse as it propagates through a large volume of plasma, which can be hard to regulate. Plasma amplifiers can have difficulty creating a sufficiently uniform large plasma and accounting for the complexity of nonlinear plasma wave dynamics. In the CPA system 118, the compression can primarily occur outside the plasma, and the plasma optical element can have a size and configuration that is much easier to control than a larger region of plasma.

The plasma transmission gratings disclosed herein can have the advantage that the modulation of the refractive index and the plasma thickness are both relatively small, thereby reducing the impact of the nonlinearities and nonuniformity that can be problematic for Raman and Brillouin amplifiers. A transmission grating design relying on angular dispersion and free space propagation also may involve less plasma density and is less sensitive to inhomogeneity than a one-dimensional grating compressor based on a group delay via dispersive propagation within the grating itself.

The medium 112 and/or the optical element 130 (e.g., plasma grating) can have a sufficient thickness D to perform the diffraction. In some cases, the transmission grating 130 can have a finite thickness to reduce or impede energy from returning to the zeroth order beam. A minimum thickness D can depend on the amount of change applied by the interference pattern to the indices of refraction of the medium 112. The thickness of the medium 112 and/or the grating 130 can be about 10 times, about 20 time, about 30 times, about 40 times, about 50 times, about 60 times, about 70 times, about 75 times, about 85 times, about 90 times, about 95 times, about 100 times, about 105 times, about 110 times, about 115 times, about 125 times, about 150 times, about 175 times, about 200 times, about 225 times, about 250 times, about 275 times, about 300 times, about 350 times, about 400 times, about 500 times, about 750 times, about 1000 times, about 1500 times, about 2000 times, about 2500 times, about 3000 times, about 4000 times, about 5000 times, about 7500 times, about 10,000 times the wavelength of the light of the probe beam (e.g., average or predominant wavelength of the pulse bandwidth), or any values or ranges therebetween, although other configurations could be used. The thickness D of the medium 112 and/or grating 130 can be about 1 micron, about 5 microns, about 10 microns, about 15 microns, about 20 microns, about 30 microns, about 40 microns, about 40 microns, about 50 microns, about 60 microns, about 70 microns, about 80 microns, about 90 microns, about 100 microns, about 125 microns, about 150 microns, about 175 microns, about 200 microns, about 225 microns, about 250 microns, about 300 microns, about 400 microns, about 500 microns, about 750 microns, about 1000 microns, about 1.5 mm, about 2 mm, about 2.5 mm, about 5 mm, about 7.5 mm, about 10 mm, about 25 mm, about 50 mm, about 75 mm, about 100 mm, or any values or ranges therebetween, although other thickness could also be used in some cases.

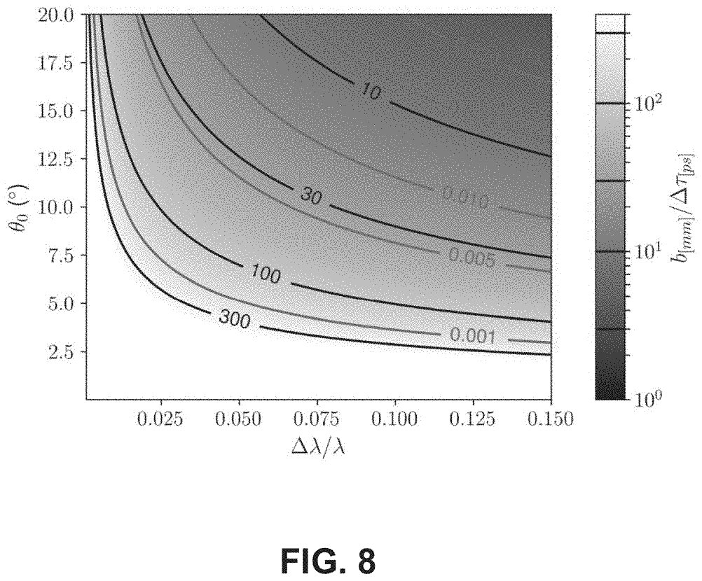

The interference pattern 128 can produce index modulations on the order of about 1%, or the various other index modulation values discussed herein, which, although lower than the index modulation achievable with solid-state holograms, can be sufficient to construct a diffractive optic 130 for pulse compression, as discussed herein. The interference pattern 128 can produce an index modulation of the medium 112 of about 0.001%, about 0.002%, about 0.003%, about 0.005%, about 0.007%, about 0.01%, about 0.025%, about 0.05%, about 0.075%, about 0.1%, about 0.25%, about 0.5%, about 0.6%, about 0.7%, about 0.8%, about 0.9%, about 1%, about 1.1%, about 1.2%, about 1.3%, about 1.4%, about 1.5%, about 1.6%, about 1.7%, about 1.8%, about 1.9%, about 2%, about 2.5%, about 5%, about 7.5%, about 10%, about 15%, about 20%, about 25%, about 30% or more, or any values or ranges between these values, although other index modulation amounts can be used in some cases. The interference pattern 128 can produce an index modulation of the medium 112 of about 0.0001 to 0.3, or any values or ranges therebetween, as discussed herein, although other configurations are possible. The available index modulation can affect the design envelope for a plasma compressor. FIG. 8 is a graph showing a design space of a plasma-transmission-grating-based compressor. FIG. 8 shows a distance b between gratings 160 and 130 for compressing a pulse 152 having a bandwidth (Δλ/λ) and angle of incidence θ₀ on the grating 130. In FIG. 8, the shading scale (on right) indicates the distance b that would provide one picosecond of compression or normalized to compression in picoseconds. Dark lines indicate threshold distances for b of 10, 30, 100, and 300 mm per 10 ps of compression. For example, a 10 ps chirped pulse with Δλ/λ₀=0.1 incident at θ₀=10 degrees would have a distance of b=240 mm between the two gratings 160 and 130 of its compressor. If the angle of incidence is only 1 degree, the spacing would become almost 25 m. Another set of lighter lines in FIG. 8 indicates the upper bound of the designs for given values (0.001, 0.005, 0.010, 0.020, and 0.030) of the index of refraction change in the medium due to the interference pattern (e.g., n₁ or Δn/n). The lighter lines mark the maximum Bragg angle that can be used for a specific n₁ as a function of Δλ/λ₀. High efficiency diffraction would be well below these lines. Thus, for a diffraction grating 130 with relatively small amounts of variation in the indices of refraction, more spacing is used between the gratings 160 and 130.

In some cases, large spacing between the gratings 160 and 130 is not compatible with the system, or can be inconvenient or expensive to implement. The double compression architecture discussed in connection with FIG. 7 can compensate for low angular dispersion of plasma gratings. The first stage or first compressor 150 can be configured to perform part of or most of the compression, but without raising the peak power or light intensity to the level that it can damage the optical elements. Then the second stage or second compressor 154 can be used to perform only the final portion of the compression (e.g., for which the peak power or intensity is possibly over a damage threshold for other optical elements). The two-compressor approach can enable the CPA system 118 to be compact while producing high intensity laser pulses. In some embodiments, the first compressor can be omitted. The CPA system 118 can include a single stage compressor 154, which can use the plasma grating 130. Or alternatively, more or less compressors and/or amplifiers/amplification stages may be included.

For Δλ/λ₀=0.1 and n₁=0.01, the angle θ₀ can be less than 10 degrees, and can correspond to a value for b of 30 mm for each 1 ps of compression from the second compressor 154. With n₁=0.01, the compressor 154 may be limited to b values over 30 mm per ps of compression, for most femtosecond-pulse bandwidths. Some CPA systems have stretched pulse durations on the order of 1 ns, which may involve a b length with a length that would render single-stage compressor using only the compressor 154 impractical for many applications. For example, for compression of 1 ns, the distance b may be about 30 meters. The double compressor configuration of FIG. 7 can mitigate this issue by using solid-state gratings to compress from 1 ns to 10 ps and a compressor where the final optic is plasma is used to compress from 10 ps to 10 fs. In this case, the final compressor grating separation distance b is only 30 cm, and the solid-state gratings only tolerate powers three orders-of-magnitude less than the final plasma optic. The distance b between the grating 160 and the grating 130 can be about 1 mm, about 5 mm, about 10 mm, about 15 mm, about 20 mm, about 25 mm, about 30 mm, about 35 mm, about 40 mm, about 50 mm, about 60 mm, about 70 mm, about 80 mm, about 90 mm, about 100 mm, about 125 mm, about 150 mm, about 175 mm, about 200 mm, about 250 mm, about 300 mm, about 350 mm, about 400 mm, about 500 mm, about 600 mm, about 750 mm, about 1 m, about 1.25 m, about 1.5 m, about 1.75 m, about 2 m, about 2.5 m, about 3 m, about 3.5 m, about 4 m, about 4.5 m, about 5 m, about 6 m, about 7 m, about 8 m, about 9 m, about 10 m, about 12 m, about 15 m, about 20 m, about 25 m, about 30 m, about 40 m, about 50 m or more, or any values or ranges therebetween, although other configurations can be used.

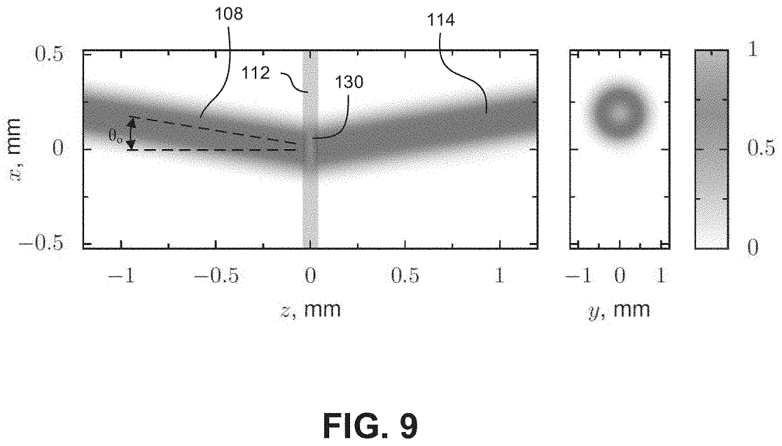

FIG. 9 shows the propagation of an infinitely-long, λ₀=800 nm beam (with an incidence angle θ₀ of 10 degrees) from left to right through a transmission grating 130 formed by the interference of two pump beams in a medium 112 with height H of about 800 microns and a thickness D of about 80 microns. The interference pattern can develop an intensity-dependent index modulation n1 of 0.00525. Under these conditions about 99.7% of the incident energy deflects into the first order. FIG. 9 also shows that the diffracted beam substantially maintains the spatial quality of the incident light.

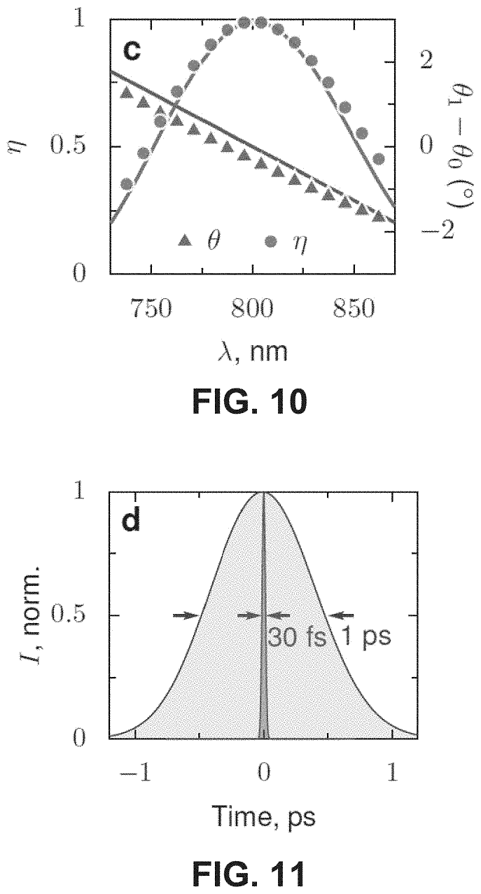

With reference to FIG. 10, changing the wavelength of the incident light while keeping the same incidence angle can cause the efficiency of the grating to drop and the first-order diffraction angle (θ₁) can change.

FIG. 11 shows the time-envelopes of a pulse 100 mm before (duration 1 ps) and 5 mm after (duration 30 fs) the operation of the grating 130 of FIG. 9. The pulse width or durations can be taken at the full width corresponding to half the maximum height (FWHM). The grating 130 can diffract all frequency components of the incident pulse with high efficiency and can substantially entirely undo the angular chirp (e.g., provided by the stretcher), to provide a high-quality 30-fs pulse that can propagate without further distortion. Similar performance can be observed in simulations of an entire sequence of four gratings (e.g., similar to the compressor 154 of FIG. 7), which with appropriately chosen spacing can compress a temporally chirped (but spatially and angularly uniform) pulse. In some embodiments, the system would use a plasma grating only for the final transmission optic of the compressor.

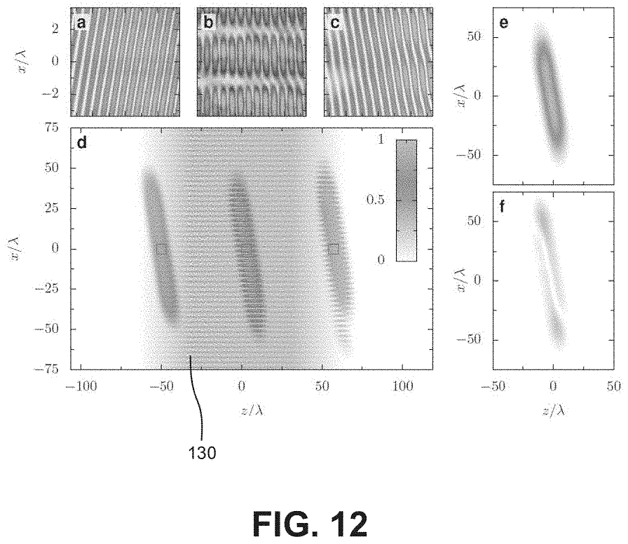

FIG. 12 shows results from simulations of pulse compression via a plasma grating. Two 600 fs pump beams (λₚ=1 micron, I=2×10¹⁵ W/cm²) were crossed with (θₚ=11.5 degrees) in a fully-ionized hydrogen plasma with a trapezoidal profile and peak density nₑ=8.7×10¹⁹. Ponderomotively driven electrons can drag the ions away from regions of high intensity, forming a plasma grating structure 130 in picoseconds, as shown in FIG. 12. A probe beam with angular, spatial, and temporal chirp corresponding to a pulse duration of 1 ps at z=−10 mm propagates with an incident angle θ₀ of 9.2 degrees through this grating 130 2 ps after the pump beams, and is diffracted into its first order with 88% efficiency. Parts a, b, and c of FIG. 12 show how the phase fronts of the probe beam shift as it propagates through the grating. In part a of FIG. 12, the phase fronts correspond to propagation at θ₀=−9.2 degrees. In part b of FIG. 12, interference between the almost-equal-energy diffracted and undiffracted components create a modulation in x. In part c of FIG. 12, with most of the energy diffracted into the first order, the phase fronts correspond to propagation at θ₀=+9.2 degrees, with some slight modulation due to interference with the residual zeroth order beam. The intensity envelopes of the diffracted and residual zeroth-order pump beams are shown in parts e and f of FIG. 12, respectively.

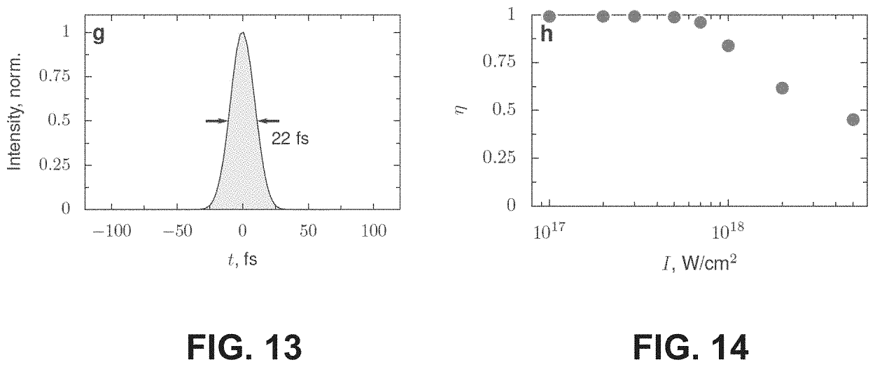

FIG. 13 shows the high intensity diffracted probe beam, with a spatial quality and 22 fs pulse duration after interaction with the grating 130 of FIG. 12. The probe intensity (e.g., 3×10¹⁷ W/cm²), diameter (e.g., 75 microns), and compressed pulse duration (e.g., 22 fs) can correspond to a 13 TW laser with 300 mJ of energy. The plasma grating 130 can have a thickness of less than 100 microns, rather than the several centimeter final grating for a 10 TW laser, which could apply for other configurations or approaches.

With reference to FIG. 14, as the probe intensity increases, grating efficiency eventually drops. At these conditions, with a 30 fs probe beam, diffraction efficiency starts to fall above 5×10¹⁷ W/cm². The diffraction efficiency remains above 95% for intensities up to 7×10¹⁷ W/cm²—almost the relativistic threshold. At those intensities, the probe laser can be sufficiently strong to disrupt the plasma grating 130 even during its relatively short duration, which can lead to a distorted beam profile and a lower diffraction efficiency. The CPA system 118 and plasma grating 130 can be used to make multi-petawatt to exawatt lasers. The output laser pulse can have light intensity of about 1×10¹² W/cm², about 5×10¹² W/cm², about 1×10¹³ W/cm², about 5×10¹³ W/cm², about 1×10¹⁴ W/cm², about 5×10¹⁴ W/cm², about 1×10¹⁵ W/cm², about 5×10¹⁵ W/cm², about 1×10¹⁶ W/cm², about 5×10¹⁶ W/cm², about 1×10¹⁷ W/cm², about 2×10¹⁷ W/cm², about 3×10¹⁷ W/cm², about 4×10¹⁷ W/cm², about 5×10¹⁷ W/cm², about 6×10¹⁷ W/cm², about 7×10¹⁷ W/cm², about 8×10¹⁷ W/cm², about 9×10¹⁷ W/cm², about 1×10¹⁸ W/cm², about 2×10¹⁸ W/cm², about 3×10¹⁸ W/cm², about 4×10¹⁸ W/cm², about 5×10¹⁸ W/cm², or any values or ranges therebetween, although other values could be used in some configurations.

Although examples are show in the figures above, such as FIGS. 8-14, the features of these examples should not be considered limiting as the systems, devices, methods may be different and include a wide range of variations.

Additional Information

In some embodiments, the methods, techniques, microprocessors, and/or controllers described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination thereof. The instructions can reside in RAM memory, flash memory, ROM memory, EPROM memory, EEPROM memory, registers, hard disk, a removable disk, a CD-ROM, or any other form of a non-transitory computer-readable storage medium. Such special-purpose computing devices may also combine custom hard-wired logic, ASICs, or FPGAs with custom programming to accomplish the techniques. The special-purpose computing devices may be desktop computer systems, server computer systems, portable computer systems, handheld devices, networking devices or any other device or combination of devices that incorporate hard-wired and/or program logic to implement the techniques.

The microprocessors or controllers described herein can be coordinated by operating system software, such as iOS, Android, Chrome OS, Windows XP, Windows Vista, Windows 7, Windows 8, Windows 10, Windows Server, Windows CE, Unix, Linux, SunOS, Solaris, iOS, Blackberry OS, VxWorks, or other compatible operating systems. In other embodiments, the computing device may be controlled by a proprietary operating system. Conventional operating systems control and schedule computer processes for execution, perform memory management, provide file system, networking, I/O services, and provide a user interface functionality, such as a graphical user interface (“GUI”), among other things.

The microprocessors and/or controllers described herein may implement the techniques described herein using customized hard-wired logic, one or more ASICs or FPGAs, firmware and/or program logic which causes microprocessors and/or controllers to be a special-purpose machine. According to one embodiment, parts of the techniques disclosed herein are performed a controller in response to executing one or more sequences instructions contained in a memory. Such instructions may be read into the memory from another storage medium, such as storage device. Execution of the sequences of instructions contained in the memory causes the processor or controller to perform the process steps described herein. In alternative embodiments, hard-wired circuitry may be used in place of or in combination with software instructions.

Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the techniques described herein may be implemented in analog circuitry or mixed analog and digital circuitry.

Unless the context clearly requires otherwise, throughout the description and the claims, the words “comprise,” “comprising,” “include,” “including,” and the like are to be construed in an inclusive sense, as opposed to an exclusive or exhaustive sense; that is to say, in the sense of “including, but not limited to.” The words “coupled” or connected,” as generally used herein, refer to two or more elements that can be either directly connected, or connected by way of one or more intermediate elements. Additionally, the words “herein,” “above,” “below,” and words of similar import, when used in this application, shall refer to this application as a whole and not to any particular portions of this application. Where the context permits, words in the Detailed Description using the singular or plural number can also include the plural or singular number, respectively. The words “or” in reference to a list of two or more items, is intended to cover all of the following interpretations of the word: any of the items in the list, all of the items in the list, and any combination of the items in the list. All numerical values provided herein are intended to include similar values within a range of measurement error.

Although this disclosure contains certain embodiments and examples, it will be understood by those skilled in the art that the scope extends beyond the specifically disclosed embodiments to other alternative embodiments and/or uses and obvious modifications and equivalents thereof. In addition, while several variations of the embodiments have been shown and described in detail, other modifications will be readily apparent to those of skill in the art based upon this disclosure. It is also contemplated that various combinations or sub-combinations of the specific features and aspects of the embodiments may be made and still fall within the scope of this disclosure. It should be understood that various features and aspects of the disclosed embodiments can be combined with, or substituted for, one another in order to form varying modes of the embodiments. Any methods disclosed herein need not be performed in the order recited. Thus, it is intended that the scope should not be limited by the particular embodiments described above.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. Any headings used herein are for the convenience of the reader only and are not meant to limit the scope.

Further, while the devices, systems, and methods described herein may be susceptible to various modifications and alternative forms, specific examples thereof have been shown in the drawings and are herein described in detail. It should be understood, however, that the disclosure is not to be limited to the particular forms or methods disclosed, but, to the contrary, this disclosure covers all modifications, equivalents, and alternatives falling within the spirit and scope of the various implementations described. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication.

The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including ambient temperature and pressure.

1. A laser pulse compressor comprising:
a medium, or a supply configured to provide a medium, or a support configured to hold a medium;
at least one laser configured to provide first and second laser beams that are disposed with respect to each other and with respect to the medium so that the first and second laser beams interfere and form an interference pattern on the medium to produce a diffraction grating; and
one or more optical elements configured to receive a third laser beam that comprises a laser pulse having a first pulse width and including light of different wavelengths, to direct the different wavelengths of light along different paths with different distances, and to direct the different wavelengths of light to the diffraction grating formed in the medium;
wherein the diffraction grating formed in the medium is configured to diffract the light of different wavelengths to produce an output laser pulse having a second pulse width that is shorter the first pulse width.

2. The laser pulse compressor of claim 1, wherein one or more optical elements are configured to direct the light of different wavelengths to the diffraction grating formed in the medium at different incoming angles, and wherein the diffraction grating formed in the medium is configured to diffract the light so that the light of different wavelengths propagates away from the diffraction grating at substantially the same angle.

3. The laser pulse compressor of claim 1, wherein the one or more optical elements comprises:
a first dispersive optical element configured to disperse the third laser beam so that the light of different wavelengths propagates away from the first dispersive optical element at different angles:,
a second dispersive optical element configured to receive light from the first dispersive optical element and to at least partially counter angular dispersion from the first dispersive optical element to substantially collimate the light of different wavelengths; and
a third optical element configured to receive light from the second dispersive optical element and to converge the light of different wavelengths towards the grating produced at the medium.

4. (canceled)

5. (canceled)

6. (canceled)

7. (canceled)

8. (canceled)

9. (canceled)

10. (canceled)

11. (canceled)

12. (canceled)

13. (canceled)

14. The laser pulse compressor of claim 1, wherein the at least one laser comprises a first laser that is configured to produce the first and second laser beams.

15. The laser pulse compressor of claim 14, comprising one or more optical elements configured to redirect the first laser beam and/or the second laser beam so that they overlap at the medium.

16. (canceled)

17. (canceled)

18. (canceled)

19. (canceled)

20. (canceled)

21. (canceled)

22. The laser pulse compressor of claim 1, wherein the interference pattern between the first laser beam and the second laser beam creates a plurality of linear fringes.

23. (canceled)

24. The laser pulse compressor of claim 1, wherein the medium has an index of refraction that is dependent on light intensity.

25. The laser pulse compressor of claim 1, wherein the diffractive grating is a plasma grating.

26. The laser pulse compressor of claim 1, wherein the medium comprises gas configured to be ionized by the first and second laser beams to form a plasma.

27. (canceled)

28. (canceled)

29. (canceled)

30. (canceled)

31. The laser pulse compressor of claim 1, wherein the output laser pulse has light intensity of at least 5×10¹⁷ W/cm².

32. (canceled)

33. (canceled)

34. (canceled)

35. A chirped pulse amplification system comprising:
a chromatic stretcher configured to chromatically stretch a laser pulse;
an amplifier configured to amplify the laser pulse; and
the laser pulse compressor of claim 1 configured to chromatically compress the laser pulse.

36. The chirped pulse amplification system of claim 35, further comprising another laser pulse compressor configured to perform a first pulse compression on the laser pulse, and wherein the laser pulse compressor is disposed downstream of the another laser pulse compressor to perform a second pulse compression on the laser pulse after the first pulse compression.

37. A system comprising:
a medium, or a supply configured to provide a medium, or a support configured to hold a medium;
at least one laser configured to provide first and second laser beams that are disposed with respect to each other and with respect to the medium so that the first and second laser beams interfere and form an interference pattern on the medium to produce a diffraction grating; and
one or more optical elements configured to direct different wavelengths of light to converge toward the diffraction grating at different angles;
wherein the diffraction grating is configured to diffract the light to reduce the difference in angles between the different wavelengths of light.

38. The system of claim 37, wherein the diffraction grating is configured to output the light of different wavelengths at substantially the same angle.

39. (canceled)

40. (canceled)

41. (canceled)

42. (canceled)

43. The system of claim 37, wherein the at least one laser comprises a first laser that is configured to produce the first and second laser beams.

44. The system of claim 43, comprising one or more optical elements configured to redirect the first laser beam and/or the second laser beam so that they overlap at the medium.

45. (canceled)

46. (canceled)

47. The system of claim 37, wherein the first and second laser beams have the same wavelength.

48. (canceled)

49. (canceled)

50. (canceled)

51. (canceled)

52. The system of claim 37, wherein the interference pattern between the first laser beam and the second laser beam creates a plurality of linear fringes.

53. (canceled)

54. The system of claim 37, wherein the medium has an index of refraction that is dependent on light intensity.

55. The system of claim 37, wherein the diffractive grating is a plasma grating.

56. (canceled)

57. (canceled)

58. (canceled)

59. (canceled)

60. (canceled)

61. (canceled)

62. (canceled)

63. A laser pulse compressor system comprising:
the system of claim 37; and
one or more optical elements configured to disperse a laser pulse into different wavelengths of light, direct the different wavelengths of light along path lengths with different distances, and to converge the different wavelengths of light onto the grating formed at the medium.

64. The laser pulse compressor system of claim 63, wherein the laser pulse compressor outputs an output laser pulse that has light intensity of at least 5×10¹⁷ W/cm².

65. (canceled)

66. A chirped laser pulse amplification system comprising:
the system of claim 37;
a laser pulse stretcher configured to increase a pulse width of a laser pulse to provide a stretched laser pulse;
an amplifier configured to amplify the stretched laser pulse to provide an amplified stretched laser pulse; and
a laser pulse compressor configured to decrease the pulse width of the amplified stretched laser pulse to provide an amplified laser pulse, wherein the laser pulse compressor includes the diffraction grating produced at the medium.

67. (canceled)

68. (canceled)

69. (canceled)

70. (canceled)

71. (canceled)

72. (Canceled)

73. (canceled)

74. (canceled)

75. (canceled)

76. A laser pulse compressor comprising:
a plasma grating; and
one or more optical elements configured to direct different wavelengths of light of a laser pulse along different path lengths and to direct the different wavelengths of light to the plasma grating.

77. The laser pulse compressor of claim 76, wherein the plasma grating is a transmission grating.

78. The laser pulse compressor of claim 76, wherein the one or more optical elements are configured to converge the light of different wavelengths onto the plasma grating.

79. The laser pulse compressor of claim 76, wherein the plasma grating is configured to receive the light of different wavelengths at different angles and to diffract the light to reduce the difference in angles between the different wavelengths of light.

80. (canceled)

81. (canceled)

82. A chirped laser pulse amplification system comprising:
a laser pulse stretcher configured to increase a pulse width of a laser pulse to provide a stretched laser pulse;
an amplifier configured to amplify the stretched laser pulse to provide an amplified stretched laser pulse; and
the laser pulse compressor of claim 76.

83. (canceled)

84. (canceled)

85. (canceled)

86. (canceled)
